(19) United States
(12) Patent Application Publication
(10) Pub. No.: US 2026/0178869 A1
(43) Pub. Date: Jun. 25, 2026

(54) RFID DEVICES HAVING LOOP ANTENNAS

(71) Applicant: Avery Dennison Retail Information Services LLC, Mentor, OH (US)

(72) Inventors: Elham MORADI, Tampere (FI); Shubin MA, Tampere (FI); Antti T. LESKELÄ, Vesilahti (FI); Tanzeela MITHA, Azusa, CA (US); Muhammad RIZWAN, Chelmsford (GB)

(21) Appl. No.: 19/427,011

(22) Filed: Dec. 19, 2025

Related U.S. Application Data
(60) Provisional application No. 63/736,943, filed on Dec. 20, 2024.
(60) Provisional application No. 63/916,906, filed on Nov. 13, 2025.

(51) Int. Cl. G06K 19/077; H01Q 1/22; H01Q 7/00

(52) U.S. Cl. CPC G06K 19/0776; H01Q 1/2216; H01Q 7/00

(57) ABSTRACT

The present disclosure provides a Radio Frequency Identification (RFID) device comprising an antenna formed from an electrically conductive material, a loop operatively coupled to the antenna, and an integrated circuit (IC) operatively coupled to the feeder loop. The antenna exhibits improved performance when the RFID device is placed on packages containing high-dielectric materials.

### CROSS REFERENCE TO RELATED APPLICATIONS

The present application claims priority to U.S. Provisional Application No. 63/916,906 filed on Nov. 13, 2025, and U.S. Provisional Application No. 63/736,943 filed on Dec. 20, 2024, the entire contents and disclosure of which is hereby incorporated by reference.

### FIELD OF INVENTION

The present disclosure relates to radio frequency identification (RFID) devices and, more particularly, to environmentally adaptable RFID devices designed for efficient operation when placed on or near high-dielectric, lossy materials.

### BACKGROUND

Radio Frequency Identification (RFID) technology has become increasingly important in various industries for tracking and managing products. RFID tags offer several benefits, including improved inventory control, reduced waste, and enhanced product tracking and traceability. However, the performance of RFID tags can be significantly affected by the materials to which they are attached or in close proximity. Lossy and high-dielectric materials are a particular challenge.

One such challenging application is in the food industry and involves using RFID tags with packaged meat or fish products. These products are electrically lossy and have a high-dielectric constant, κ. The dielectric constant of a material is the ratio of its permittivity to the permittivity of free space (referred to as “relative permittivity,” εᵣ). Both terms will be used interchangeably herein.

Typically, when a dipole antenna is placed near food proteins with relative permittivity values between 35 and 60, its impedance changes due to interactions with the surrounding medium. The antenna's electric field couples with the protein, and the high permittivity material slows the electromagnetic wave propagation. As a result, the effective wavelength shortens, causing the resonant frequency to shift downward. In other words, the dipole antenna resonates at a lower frequency than it would in free space, which adversely affects the RFID tag's ability to transmit a signal that can be successfully received by an accompanying RFID reader.

Another important effect is that the dipole demonstrates a reduction in radiation resistance when it is near high-permittivity materials. It is believed that this occurs because the dielectric absorbs some of the energy that would typically radiate into free space. Because proteins are both high in permittivity and lossy, they absorb additional energy and convert it into heat, further lowering the antenna's overall radiation efficiency. The challenges are further compounded in scenarios where RFID-tagged products are stacked or densely packed, such as in-store coolers or during transportation. In these situations, the presence of multiple layers of high-dielectric materials between the RFID tag and the reader can significantly attenuate the radio frequency signals, making it difficult to achieve consistent and reliable tag reads.

Additionally, the diverse nature of products in industries such as food retail presents varying dielectric environments. Different types of meats, produce, packaged goods, and other lossy, high-dielectric materials each present unique and specific challenges for RFID tag performance. For example, the high water content of meat absorbs radio waves, particularly in the ultra-high frequency (UHF) band in which RFID tags typically operate. The water in meat also contains salts, which increase the absorptive effect. In other cases, fat is less absorptive than muscle or salt water, so each type of meat (e.g., beef, pork, chicken, fish, etc.), as well as different cuts of each type of meat (e.g., filets, ground meat, etc.), will absorb UHF signals differently. In addition, chicken is often treated with a saltwater brine, making it a particularly challenging application for RFID tags. This variability necessitates RFID solutions that can adapt to a wide range of material properties and environmental conditions.

Furthermore, the physical constraints of product packaging and labeling often limit the size and placement options for RFID tags. This restriction makes it challenging to design antennas that are both compact enough to fit within the available space and efficient enough to perform well in high-dielectric environments.

As the adoption of RFID technology continues to grow across various industries, there is an increasing need for RFID tags that can maintain reliable performance when applied to or used in proximity to high-dielectric, lossy materials. Improved RFID tag designs that can overcome these challenges while remaining cost-effective and suitable for high-volume manufacturing are highly desirable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In general the embodiments described herein relate to a RFID device having RFID integrated circuit chip and an antenna structure with one or more loop configurations. The configuration and construction of the antenna may be defined with parameters to provide improved total efficiency and radiation efficiency when the RFID device may be placed on packages that are near or on high-dielectric materials or may be applied to a label having at least one adhesive surface, which is the label is placed on packages with high-dielectric materials. The antenna may be configured as a loop antenna or a modified loop antenna, including T-match loop antennas, reversed T-match loop antennas, or modified versions of either antenna.

According to an aspect of the present disclosure there is provided a RFID antenna comprising a feeder loop having pads at each end configured to connect to an integrated circuit chip, and wherein the feeder loop has a shape having a y-height on the y-axis, a loop antenna comprising a conductive trace; and a conductive bridge configured to connect the feeder loop to the loop antenna to provide a minimum coupling height. In some embodiments, this RFID antenna may have the following parameters to achieve improved performance. The parameters include a maximum y-height ranging from 5 mm to 7 mm, the width of the conductive bridge ranging from 1.7 mm to 6.3 mm, the minimum coupling height between the loop antenna and feeder loop ranging from 0.8 mm to 1.7 mm, the loop antenna has a maximum width on the x-axis ranging from 50 mm to 75 mm, the conductive trace defines a perimeter of the loop antenna and wherein the perimeter ranging from 174 mm to 200 mm, and the conductive trace has an average width ranging from 0.8 mm to 1.1 mm. In some embodiments, there is provided an RFID device comprising the RFID integrated circuit chip and this antenna. The RFID device may be applied to the package containing a high-dielectric material directly or may be applied to a label that is attached to the package containing a high-dielectric material.

According to an aspect of the present disclosure, there is provided a RFID antenna comprising a feeder loop having pads at each end configured to connect to an integrated circuit chip, and wherein the feeder loop has a shape having a first diameter and a second diameter perpendicular to the first diameter, wherein the first diameter is greater in length than the second diameter, a loop antenna comprising a top conductive trace that connects opposing conductive segments, and wherein the loop antenna has a recessed portion, and a conductive bridge opposite to the pads, wherein the conductive bridge connects the feeder loop to the loop antenna portion, wherein the loop antenna portion is connected to the conductive bridge in the recessed portion, and wherein the top conductive trace is opposite to the conductive bridge, and wherein at least one segment of the opposing conductive traces has a length that is longer than the first diameter. In some embodiments, there is provided an RFID device comprising the RFID integrated circuit chip and this antenna. The RFID device may be applied to the package containing a high-dielectric material directly or may be applied to a label that is attached to the package containing a high-dielectric material.

Some embodiments of a Radio Frequency Identification (RFID) device are provided herewith. The RFID device includes an antenna formed from an electrically conductive material and an impedance-matching loop operatively coupled to the antenna. The RFID device further includes an integrated circuit (IC) operatively coupled to the impedance-matching loop. The RFID device has a first and second side, and may exhibit a first directional sensitivity pattern when a first dielectric material is located within a first distance of the first side of the device. The RFID device may exhibit a second directional sensitivity pattern in a predetermined direction when the first dielectric material is located within the first distance of the first side of the device and a second dielectric material is located within a second distance of the second side of the device.

In some cases, a RFID device is provided. The RFID device may include a first line of conductive material defining a loop antenna and a slot and a second line of conductive material connected to the first line of conductive material at a first and second location. The RFID device may further include an IC operatively connected to the first line of conductive material across the slot. The RFID device has a first and second side, and the antenna may exhibit a first directional sensitivity pattern when a first dielectric material is located within a first distance of the first side of the device. The RFID device may exhibit a second directional sensitivity pattern in a predetermined direction when the first dielectric material is located within the first distance of the first side of the device and a second dielectric material is located within a second distance of the second side of the device.

In some cases, a method of responding to RFID interrogation signals by a RFID device is provided. In the method, the RFID device may receive a first RFID interrogation signal from a RFID reader within a first directional sensitivity when a first dielectric material is located within a first distance of a first side of the RFID device. The RFID device may transmit a first RFID response signal in the first directional sensitivity, the first directional sensitivity being configured to intersect with a read aperture of the RFID reader. The RFID device may receive a second RFID interrogation signal from the RFID reader within a second directional sensitivity when the first dielectric material is located within the first distance of the first side of the RFID device and a second dielectric material is located within a second distance of a second side of the RFID device. The RFID device may transmit a second RFID response signal in the second directional sensitivity in a predetermined direction, wherein the second directional sensitivity is configured to intersect with the read aperture of the RFID reader.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a conventional RFID device.

FIG. 1B illustrates a conventional RFID device and its radiation pattern.

FIG. 1C illustrates a conventional RFID device with a modified radiation pattern.

FIG. 2 illustrates a RFID device placed on a package containing a high-dielectric material according to aspects of the present disclosure.

FIGS. 3A-B illustrate a package having a RFID device according to aspects of the present disclosure.

FIGS. 3C-D illustrate stacked configurations of packages with a RFID device, according to aspects of the present disclosure.

FIG. 4A illustrates a graph of reflection coefficients for a reversed T-match impedance matching antenna of Example 4.

FIG. 4B illustrates a graph of total radiation efficiency comparing a convention design with a reversed T-match impedance matching antenna of Example 4.

FIGS. 5A-5E illustrate a RFID device having a loop antenna according to a first embodiment of the present disclosure.

FIG. 6 illustrates a RFID device having a loop antenna according to the first embodiment of the present disclosure.

FIG. 7A-7E illustrate a RFID device having a loop antenna according to a second embodiment of the present disclosure.

FIG. 8 illustrates a RFID device having a loop antenna according to the second embodiment of the present disclosure.

FIG. 9 illustrates a RFID device having a reversed T-match impedance matching antenna according to aspects of the present disclosure.

FIG. 10 illustrates a RFID device incorporating a spacer according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Radio Frequency Identification (RFID) technology has become increasingly important in various industries for tracking and managing products. However, conventional RFID tags may face challenges when used with lossy, high-dielectric materials, such as food products, liquids, or certain packaging materials. Exemplary high-dielectric materials may include proteins such as meat including but not limited to beef, chicken, turkey, pork, seafood, as well as other similar proteins. The high-electrical material is generally wrapped in a plastic film and carried on a foam tray. The relative permittivity of the plastic foam and foam tray is accounted for as part of the entire package. The RFID device may be attached to the plastic film. Without limitations, the high-dielectric materials may also include other proteins such as milk, yogurt, and eggs or egg products. The high-dielectric materials generally may have a relative permittivity (εᵣ) that is less than or equal to 60, e.g. less than or equal to 55 or less than or equal to 50. The relative permittivity (εᵣ) for high-dielectric materials should be higher than 5, e.g., preferably higher than 15 or more preferably higher than 20. The temperature of the package (frozen or thawed), moisture content, and fat percentage of the protein are all factors that can contribute to variations into the relative permittivity (εᵣ). The RFID devices described herein have improved adaptability to respond to variations across multiple types of high-dielectric materials. Accordingly, in terms of ranges, the relative permittivity (εᵣ) may be from 10 to 60, e.g., preferably from 15 to 55, preferably from 20 to 55, preferably from 25 to 55, preferably from 30 to 55, preferably from 35 to 55 or more preferably from 40 to 55. The RFID device may also be used on packages with a relative permittivity of greater than 60. These high-dielectric materials can significantly affect the performance of RFID tags by altering their resonant frequency and reducing their radiation efficiency.

The relative permittivity and loss tangent (“tan δ”) can be measured by any appropriate method using dielectric spectroscopy or resonator cavities which are commonly used dielectric analysis techniques. At ambient temperature, permittivity and dielectric losses of dielectric materials s can be considered as relatively constant in particular in the bandwidth of interest. The permittivity value of a material and also to its tan δ loss factor at a given frequency for example. Unless otherwise noted, the values indicated in this description and the claims that follow correspond to those measured at any frequency within the band of 800-1000 MHz. The measurements may be test the variation between temperature of 20° C. and freezer temperature of −18° C. In particular, the values relative permittivity and tan δ may be measured by means of a DAK-TL2 using open coaxial probes and relative permittivity and tan δ of the material under test are calculated from the reflection coefficient measured at the probe flange. In DAK-TL2, software calculates the relative permittivity and tan δ constant from the measurement on the basis of the impedance measured at the end of the open-ended coaxial probe connected to a vector network analyzer.

The present disclosure relates to environmentally adaptable RFID devices that overcomes these challenges. By adapting its characteristics based on the surrounding environment, this RFID device may maintain acceptable performance when placed on or near high-dielectric materials. As is used in the art, RFID devices may be referred to as RFID “tags,” RFID “labels” or RFID “inlays,” depending on the specific construction of the RFID device and its intended application. In any case, the disclosed embodiments are equally applicable to any of the variations implied by the different terms, and, as such, the terms are used interchangeably herein. It will be understood that the use of one term does not exclude the others from the scope of the disclosed embodiments.

In some embodiments, an environmentally adaptable RFID device may incorporate antenna designs that are configured for efficient operation across a range of dielectric conditions. These antenna designs may include features such as non-meandering antenna paths, specific impedance-matching techniques, antenna configurations, radiation pattern manipulation, or combinations thereof. The RFID device may be capable of modifying its readability, which may be a composite of sensitivity, backscatter, and radiation patterns, in response to complex dielectric and conductive environments.

In some cases, the RFID device may utilize a high initial resonance frequency in free air, which may shift to the desired operating range when placed on high-dielectric materials. This approach may allow for improved performance in challenging applications, such as tracking meat products in store coolers or identifying items packaged in materials that can attenuate or absorb RFID signals.

In some embodiments, the environmentally adaptable RFID device may provide several potential benefits, including but not limited to improved read range in stacked or cluttered scenarios, enhanced radiation efficiency, and versatility across various applications. These characteristics advantageously may make the device suitable for use in industries such as food packaging, pharmaceuticals, and manufacturing, where high-dielectric materials are commonly encountered.

In some cases, the environmentally adaptable RFID device may include various impedance-matching mechanisms to improve performance in different environments. These mechanisms may include, for example, tuning loops, T-match loops, reversed T-match loops, parasitic conductive elements, interdigital capacitors, and split ring resonators.

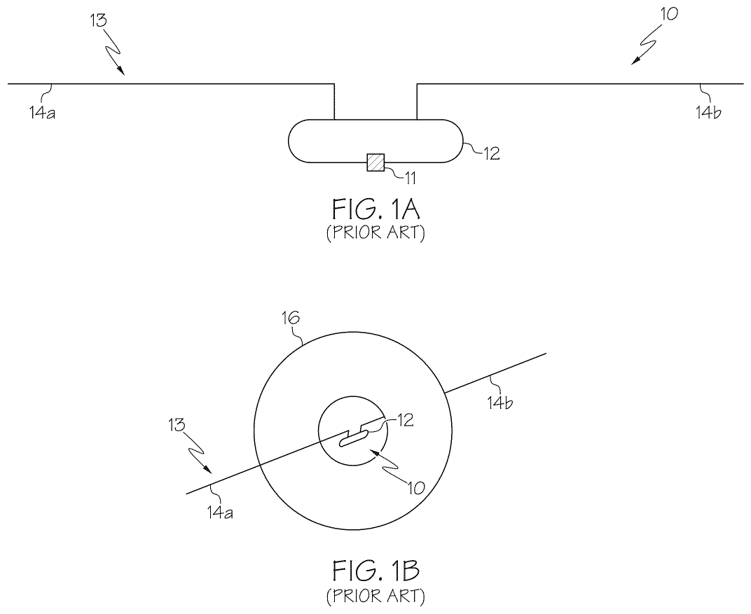

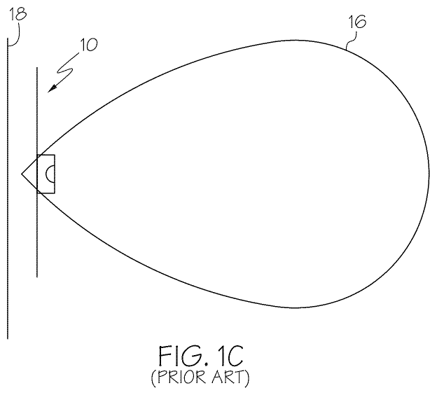

FIG. 1A illustrates a conventional RFID device 10. The RFID device 10 includes a RFID integrated circuit (IC) 11, or “chip,” which is operatively connected to a tuning and impedance-matching loop 12. The tuning and impedance-matching loop 12 may be positioned between the RFID chip 11 and the antenna 13, as shown in FIG. 1A. This particular configuration provides power transfer between the RFID chip 11 and the antenna 13. The antenna 13 of FIG. 1A is formed by two arms 14a and 14b. The dimensions of the tuning and impedance-matching loop 12 and arms 14a and 14b may be configured such that the impedance of the RFID chip 11 is transformed to be the conjugate of the antenna 13 impedance.

FIG. 1B illustrates a radiation pattern 16 associated with the conventional RFID device 10. The radiation pattern 16 may extend outward three-dimensionally (3D) from the RFID device 10 in a toroidal or donut-like shape, which may be a characteristic of many loop antennas. This radiation pattern 16 typically exhibits minimum readability in the “end on” orientation (i.e., outward from arms 14a or 14b), and maximum readability in the “face on” direction (i.e., substantially perpendicular to the end on direction). However, the radiation pattern 16 of the conventional RFID device 10 performs poorly when placed on or near high-dielectric, lossy materials.

The embodiments described herein provide improvements over the conventional RFID device 10 by providing improved designs for efficient operation. In particular, the RFID devices described herein provide improved performance when placed on or near high-dielectric, lossy materials.

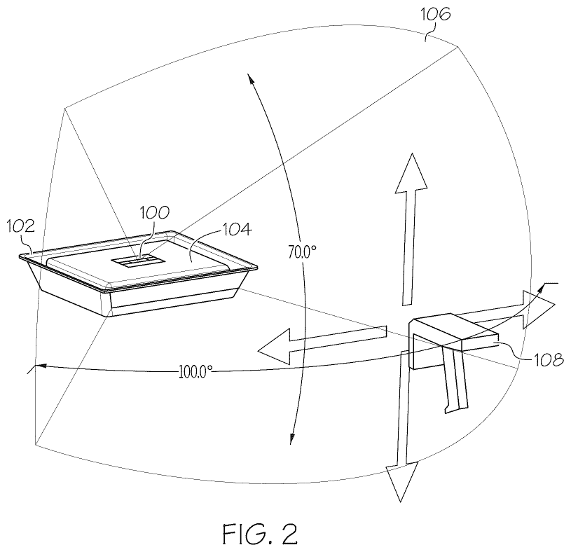

FIG. 2 illustrates a RFID system that may include a RFID device 100 positioned on a package 102 containing a lossy and high-dielectric material 104. RFID device 100 may comprise the RFID integrated circuit chip and an antenna as described further herein. The RFID device 100 may interact with a sensitivity aperture 106 of a RFID reader 108. Particularly, when an RFID reader 108 is activated, a UHF RF signal may be transmitted from the RFID reader 108. In such instances, when the RFID device 100 is influenced under the transmitted UHF RF signal, the antenna of the RFID device 100 receives and transmits back the UHF RF signal to the reader 108 with the information stored in the RFID IC chip.

In some embodiments, the information stored in the RFID IC chip may include, for example, an item identification system, an item locating system, or an item indication system. The item identification system as used herein includes item identification, item location, and item indication in one or more embodiments falling within the scope of the present subject matter.

In FIG. 2, the sensitivity aperture 106 is represented by a curved dome-like structure surrounding the package 102 and RFID device 100. For purposes of illustration, in FIG. 2 the sensitivity aperture is shown to extend 100° horizontally and 70° vertically from the RFID device 100, but it will be appreciated that other dimensions of the sensitivity aperture 106 are possible and, in some cases, desirable.

In some cases, the RFID reader 108 may be in a fixed position. In some cases, the RFID reader may be moved or moveable, as represented by the bold horizontal and vertical arrows. For purposes of discussion herein, a RFID reader 108 may be implemented as a fixed device or may be implemented as a mobile device. In some embodiments, where the relative position of a zone containing an object to which the RFID device is attached, such as a food item, the RFID reader may be fixed within the zone. A fixed RFID reader may be positioned at a point of egress to the zone. In other examples, the fixed RFID reader may be positioned to monitor devices within a sub-zone such as on a shelf, within a fridge, or within a freezer. In some embodiments, the RFID reader may be mobile, where the relative position between the RFID reader and RFID device changes over time. In the latter case, the RFID reader may be, for example, a hand-held reader or a robotic reader.

The function of a RFID device in a volume may be characterized by a number of factors; for example, the sensitivity (a function of realized gain and the minimum power incident at the device's position that will cause it to operate), an associated frequency with an associated 3D angular property (often described as a radiation pattern), or backscatter (the signal generated by the RFID device associated with a modulated change in its cross-section). All of these factors are a function of the environment in the 3D space around the RFID device, characterized as volumes of materials with different dielectric/magnetic and conductive properties at the desired operating frequency. It should be noted that these properties can also be changed by the environment such as, for example, temperature.

Turning now to FIG. 1C, intentional modification of a radiation pattern 16 of a conventional RFID device 10 has typically been performed in the art by using a metal plate 18 or a series of longer and shorter metal rods, as in a Yagi-Uda antenna. FIG. 1C depicts a modified radiation pattern 16 of the conventional RFID device 10 when positioned adjacent to a metal plate 18. In this case, the radiation pattern 16 may become asymmetrical, with the majority of the radiation directed away from the metal plate 18. However, modifications made in this way are generally fixed (i.e., the antenna is always directional under all conditions) rather than designed to create directional peaks in response to a range of different undefined materials to maximize readability. Thus, prior art approaches either add external reflectors or other conductive elements to force the radiation pattern 16 of the RFID device 10 to become directional or use an intrinsically directional design, both of which have their accompanying difficulties and detriments. As may be appreciated, such a permanently directional approach may have the same drawbacks as a permanently omnidirectional design-its inability to adapt to changing environmental conditions renders it less suitable to be read in different situations.

Unlike the conventional approaches, the disclosed RFID devices provide design(s) capable of modifying the device's readability in response to a number of complex dielectric and conductive environments, which beneficially improves the probability of the data in the RFID device being read. In some cases the readability of a device may be a composite of sensitivity, backscatter and/or radiation patterns.

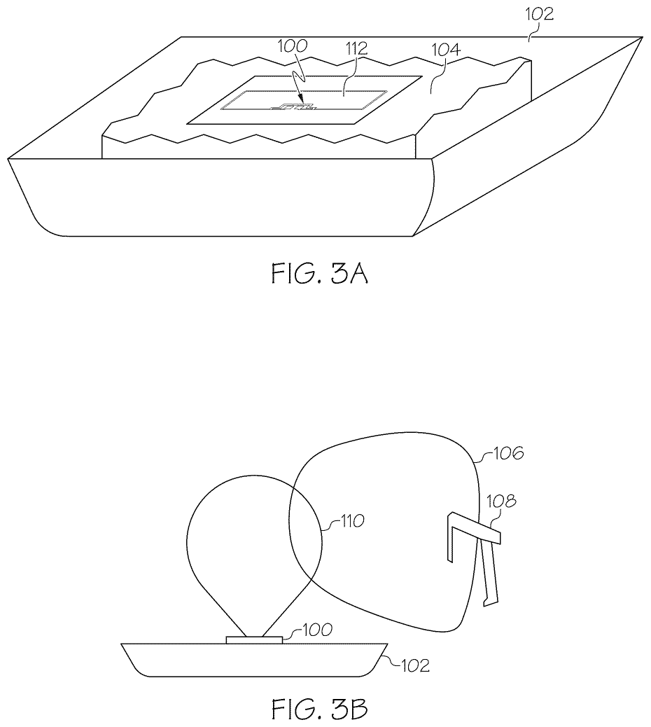

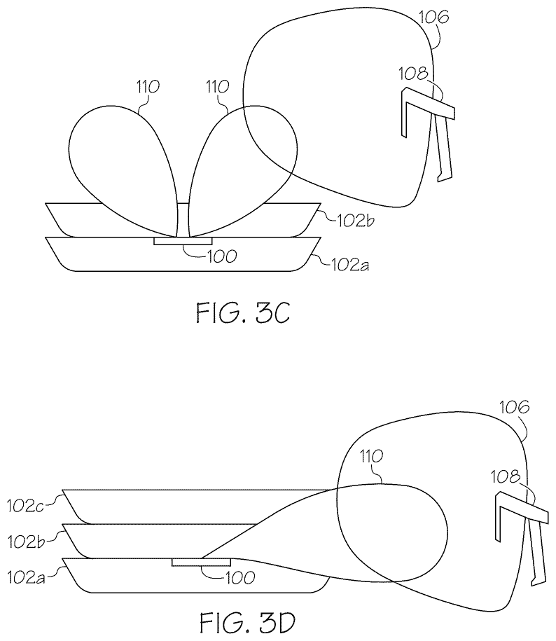

Several exemplary designs will be described in the following text and diagrams. Referring first to FIGS. 3A-D, and according to an embodiment, the adaptive radiation patterns 110 of a RFID device 100 may intersect with a sensitivity aperture 106 of a RFID reader 108. RFID device 100 comprises an antenna as described further herein for receiving and transmitting radio frequency signals to and from the RFID device 100. The RFID device 100 may be disposed on a label 112 or contained within a label 112. The label 112 may have at least one surface having an adhesive, preferably a pressure-sensitive adhesive or other similar adhesive. The label 112 may be adhered or otherwise affixed to a package 102 containing the high-dielectric material 104, such as chicken, pork, beef, or other meat products. By adapting its radiation pattern 110 in predetermined ways to intersect with the sensitivity aperture 106 of a RFID reader 108, the RFID device 100 may maintain effective communication with the RFID reader 108 across various environmental conditions.

FIG. 3A shows a RFID device 100 positioned on the top surface of a package 102 that contains a lossy and high dielectric material 104. The RFID device 100 is contained on or within the label 112 that is attached to the top surface of the package 102. Due to variations in packages, the label 112 may be placed at any point on a surface of the package 102, and in some cases, placed on a top surface or face up surface. Exemplary surfaces include the center or outer edge locations on the top surface of the package. In some embodiments, the antenna structure of the RFID device 100 provides operating range when placed on or near the lossy and high dielectric material 104. In one embodiment, the antenna structure of the environmentally adaptable RFID device 100 may be designed with a high initial resonance frequency in free air, which may shift to the desired operating range when placed on or near the lossy and high dielectric material 104. It will be appreciated that the direction for a radiation pattern 110 depends on the location of the RFID reader 108 and, for example, whether the RFID reader 108 moves relative to the package 102. In some cases, the RFID reader 108 may scan a space containing a package 100 of the lossy and high dielectric materials 104.

As depicted in FIG. 3A, the RFID device 100 is located in the center of the top of package 102. The RFID device 300 may be incorporated into a label 112, formed into the body of the package 102, or otherwise attached to the package 102. The position, size, and orientation of the RFID device 100 may be selected to complement its design and the characteristics of its radiation pattern 110 in the various environments in which the RFID device 100 is intended to operate. For example, the RFID device may be sized so it fits within an existing label's dimensions so printers and other food production equipment do not require extensive modifications, if any modifications at all, to incorporate the RFID devices 100. The RFID device 100 may be placed on a package 102 at a location that enhances the readability of the RFID device 100. In some embodiments, the RFID device 100 may be placed toward an edge or corner of a package 102 so it is more readily able to receive RFID interrogation signals from a RFID reader 108 and transmit a RFID response signals back (by being closer to open air on the side of a stack of packages 100).

FIG. 3B depicts a RFID device 100 on a single package 102, demonstrating how the radiation pattern 110 (also referred to as a “lobe of readability”) may propagate outward from the RFID device 100 in such a configuration. The radiation pattern 110 depicted in FIG. 3B is for illustrative purposes only, as any shape or size of radiation pattern 110 that is consistent with embodiments disclosed herein may propagate outward from the RFID device 100.

In the configuration illustrated in FIG. 3B, a RFID reader 108 would likely have a line-of-sight view of the RFID device 100. As noted above, the RFID device 100 may create multiple radiation patterns 110, and/or a differently shaped radiation pattern 110, in response to different environmental conditions. In some embodiments, the RFID device 100 may create at least one directional sensitivity pattern 110 configured to intersect with a read aperture 106 of a RFID reader 108. FIG. 3C illustrates a RFID device 100 positioned on a lower package 102a, on which an upper package 102b has been stacked. Typically, a second RFID device would be positioned on the upper package 102b, but for clarity, only the RFID device 100 of the lower package 102a is depicted in FIG. 3C. In FIG. 3C, each package 102a and 102b may contain a high-dielectric material. It will be appreciated that when the high dielectric materials 104 are meat, e.g., chicken, pork, fish, or some other type of protein, the contents of packages 102a and 102b may not be exactly the same, even if each package 102a and 102b contains the same general type of meat. For example, each package 102a and 102b may contain a slightly different cut of protein, the protein may have a different pattern of fat, there may be slightly different amounts of protein, and so forth. Even with this in mind, the disclosed RFID device 110 should still produce a radiation pattern 110 that is likely to be read by a RFID reader 108. Put another way, the peak gain of an antenna of the RFID device 110 should be within a read aperture 106 of the RFID reader 108 even when the contents of each package 102a and 102b is not uniform. Such a radiation pattern 110 may be depicted, for example, as two lobes extending outward from the sides of the RFID device 110, parallel to the planes of packages 102a and 102b. It will be appreciated that the direction(s) in which the lobes extend in this scenario will be predetermined by the characteristics of the RFID device 100, such as, for example, the various structural elements of the antenna structure as disclosed herein.

FIG. 3D further demonstrates how a RFID device 100 may adapt its radiation pattern 110 when the RFID device 100 is positioned between multiple layers of high dielectric material. In FIG. 3D, a RFID device 100 is disposed on a lower package 102a, an upper package 102b, and a top package 102c (only the RFID device 100 of the lower package 102a is depicted in FIG. 3D for clarity). As shown, the radiation pattern 110 of the RFID device 100 of the lower package 200a may extend primarily to the side of the stacked packages 102a-c. As transmitting through multiple layers of packages 102b, 102c and associated high-dielectric materials would be difficult in some cases, if not impossible, it will be appreciated that having a radiation pattern 110 that extends to the side (i.e., toward an air gap, open region, RFID reader 108, or the like) may allow for effective signal transmission even when the RFID device 100 is sandwiched between such high-dielectric materials.

To overcome the challenges associated with high-dielectric materials, the environmentally adaptable RFID device may incorporate design features that allow for improved performance in high-dielectric environments. A number of factors have been found to improve the performance of the environmentally adaptable RFID device in multiple environments and may create environmentally dependent directional properties. One skilled in the art will appreciate that although they are described separately herein, one or more of these features may be active at one time to achieve the desired performance.

For example, the improved performance may result from designing an antenna structure whose radiating elements bring a high resonance frequency in free air above the assigned operational frequency band for RFID in the country or region associated with the application. For example, the operational frequency band could be 902-928 MHz in the USA, 865-868 MHz in some parts of Europe, and 860-930 MHz according to the GS1 “Gen2” air interface protocol. Using an initial high frequency ensures that when the environmentally adaptable RFID device is placed proximate to a high-dielectric material, it falls into the desired operating frequency range. In other words, the dielectric loading effect may lower the resonance to the desired operating range.

At resonance, the current distribution of a full-wave loop antenna along the loop's circumference forms a standing wave. This wave is characterized by two distinct current maximums and two current minimums.

Balancing radiation efficiency and impedance-matching—both of which are desirable characteristics—presents a challenge: a larger antenna footprint improves radiation efficiency, while a smaller dipole ensures better impedance-matching.

Antenna radiation efficiency can also be expressed as:

$${η}_{r} = {P}_{rad} / {P}_{in}$$

where:
P_{rad} is the radiated power by the antenna; and
Pᵢₙ is the input power supplied to the antenna.

Antenna total efficiency can also be expressed as:

$${η}_{t} = {P}_{rad} / {P}_{incidental}$$

where:
P_{rad} is the radiated power by the antenna; and
P_{incidental} is the incidental power supplied to the antenna.

In some embodiments, to achieve this high initial resonance, an antenna of the environmentally adaptable RFID device may use a non-meandering geometry, which minimizes its electrical length while maintaining the necessary length for efficient radiation. In the context used herein, “non-meandering” refers to an antenna structure of the RFID device that has at least one external edge that is substantially straight or curved. In some embodiments, each of the external edges may be non-meandering. In some embodiments, the antenna configuration may have at least one external edge that is meandering, which is characterized by a back-and-forth antenna pattern.

In some embodiments, a non-meandering antenna may be preferred and such constructs may avoid areas of high current density, which would occur at the tight bends characteristic of a meandering antenna and decreases the antenna's radiation efficiency. While, as will be discussed below, non-meandering antennas may come in different shapes and may have some bends, notches, channels, etc., formed therein, the overall design of a non-meandering antenna may have a reduced number of such bends or bends having a reduced height. When such bends occur, they may be formed to reduce the current density such as, for example, being at an obtuse angle or rounded. In some embodiments, for example, 90° bends may be avoided, while in other embodiments, sharp bends may be used. A meandering conductive trace forces currents to flow in opposite directions in tightly-spaced segments, which causes their electromagnetic fields to partially cancel each other out, thus reducing the power radiated. Furthermore, this proximity effect induces eddy currents that increase the wire's resistance, converting more of the input power into wasted heat instead of radio waves.

It will be understood that a non-meandering antenna comprising a loop antenna that may be operatively connected to a feeder loop or matching loop that does not affect the overall non-meandering nature of the antenna. It will be further understood that other deviations to the edges of such an antenna do not need to be entirely absent to remain non-meandering as used herein. For example, notches, slots, and the like may be formed in a non-meandering antenna without affecting its overall non-meandering nature. A non-exhaustive overview of such modified non-meandering antennas is illustrated in the various figures described herein. In various embodiments discussed herein, a non-meandering antenna may be in the form of a loop antenna. The above-referenced deviations to the non-meandering antenna may be used in such loop antennas to manipulate the current flow around the perimeter of the loop to affect the antenna's performance in desired ways.

In addition, various embodiments contemplate that an environmentally adaptable RFID device may have dimensions selected such that when the antenna interacts with high-dielectric materials, its resonance shifts down into the appropriate frequency band. As a result, an antenna designed for use with high-dielectric materials may be shorter than one designed for operation in free air. However, both the smaller size and the dielectric losses may reduce radiation resistance and efficiency.

According to an embodiment, an antenna design for an environmentally adaptable RFID device that will be used with high-dielectric materials involves a balance of electrical length and physical size. While a shorter electrical length may be desirable for achieving the necessary high resonance frequency, a larger physical size—and therefore a greater surface area—typically increases radiation resistance. This increased resistance enhances the antenna's radiation efficiency, boosting its performance when applied to high-dielectric materials. However, the antenna's size may also need to be defined to fit within the constraints of the primary or secondary label, as in the case of protein tagging. In addition, increasing the size of an antenna will eventually result in a decrease of the antenna's resonance frequency.

The differences in efficiency and frequency response among these antenna designs demonstrate how various configurations of the antenna structure may affect the performance of an environmentally adaptable RFID device in different environments. By improving the antenna design, the environmentally adaptable RFID device may maintain effective operation across a range of challenging conditions, such as when placed on or near a lossy, high-dielectric material.

In addition, low capacitance and high inductance drives a response from the antenna that is primarily magnetic, rather than electrical, in nature. In other words, creating an electric field maxima that is as small as possible (given the relevant design constraints) causes most of the energy of the antenna to be directed toward generating a magnetic field. This is significant because a magnetic field can more effectively pass through high-dielectric materials than an electrical field, which tends to be absorbed or otherwise impeded.

In some embodiments, the RFID device uses an antenna having at least two loops. Preferably, one loop is contained within the larger loop. For purposes of the present disclosure the larger loop may be referred to as the loop antenna and the smaller loop as the feeder loop or matching loop. Each loop may share a conductive trace and may be overlapped. Although two loops are generally sufficient, other embodiments may use one or more loops.

In some embodiments, the RFID device may have a loop or a modified loop design. In one embodiment, the RFID device may have a T-match impedance matching antenna or a reversed T-match impedance matching antenna, or a modified antenna. For purposes of classification and convenience in this disclosure, the T-match impedance matching antenna may be described with the pads for the strap to the IC circuit being in the feeder loop, while the reversed T-match impedance matching antenna may be described with the loop antenna as having the pads. In addition, the reversed T-match impedance matching antenna may have an overlapped region between the loop antenna and matching loop. These impedance matching antennas may provide electromagnetic coupling between the feeder loop and the loop antenna, potentially improving impedance-matching in various environmental conditions. Various embodiments of these antenna structures will be described in the following embodiments. It should be understood that the antenna designs may be combined.

In some embodiments, the designs of the antennas may be formed from one or more conductive traces. The conductive traces may be joined together or may be formed as a continuous trace. Conductive traces may be used for both loops in the antenna. The conductive trace may be formed from electrically conductive material, such as copper, aluminum, silver, and including alloys thereof as well as conductive inks. In some embodiments, a single sheet of metal such as, for example, aluminum sheet or foil may be cut to form the antenna described herein. The metal sheet may be cut using for example any conventional antenna cutting methods or techniques such as die cutting, laser cutting, etching and so forth. Unless otherwise specified by the parameters disclosed herein, the conductive trace may have an average width from 0.3 mm to 3 mm, e.g., from 0.5 mm to 2.5 mm or from 0.7 mm to 1.5 mm. In one embodiment, the conductive trace may be substantially uniform around the perimeter of each loop. In one embodiment, the conductive trace defines a hollow area for the loop. The hollow area may be at least 20% or more of the total area defined by the conductive trace, and preferably at least 85% or more preferably at least 90%.

An antenna that defines a hollow area with the conductive trace for one or more loops may reduce the amount of conductive material in contact with the high-dielectric material, minimizing the dielectric loading effect and helping to maintain the desired resonant frequency while reducing losses. Reducing the amount of conductive material may also have other benefits. For example, a reduced amount of conductive material may reduce the interaction the RFID device may have with metal detector systems found in food processing facilities. In another example, the reduced metal content of a RFID device that is attached to a package (or is part of a label that is attached to a package) may have beneficial effects when the package is recycled, as there will be less conductive material to be separated from other recyclable materials.

In some embodiments, at least one of the loops may have a solid construction, with less than 20% of the area defined by the conductive trace as being open. The larger loop, i.e. loop antenna, may have a solid construction with less than 20% of the area being open. Although solid construction may be used in some embodiments, it is preferred to use loop configurations with conductive traces that define a hollow area that is more than 20% of the total area of the loop antenna.

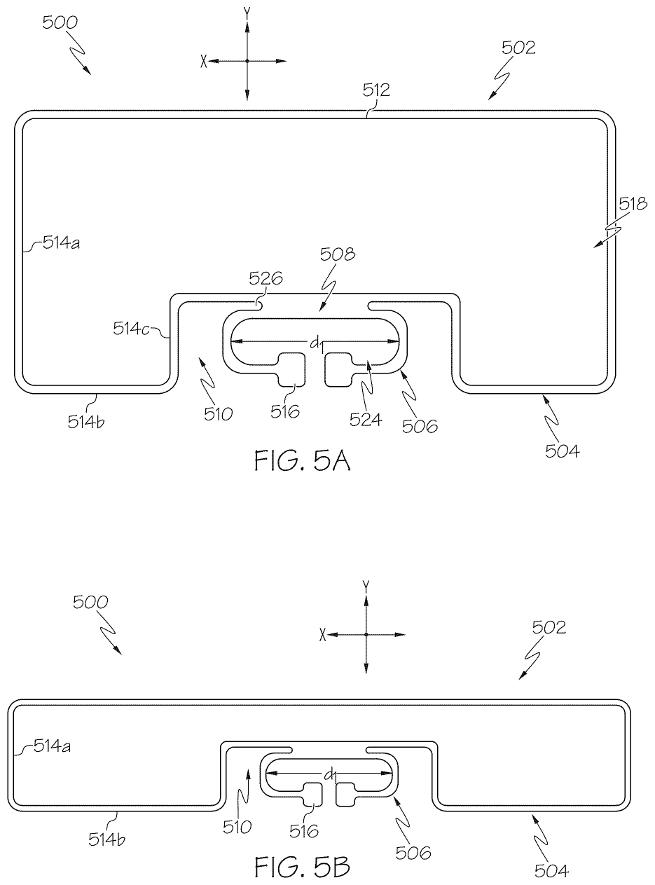

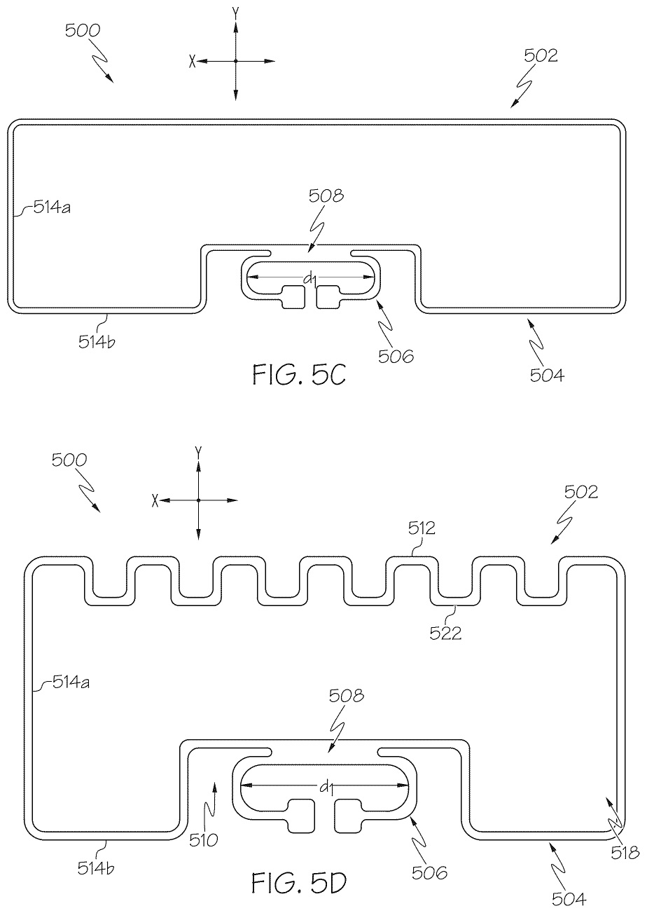

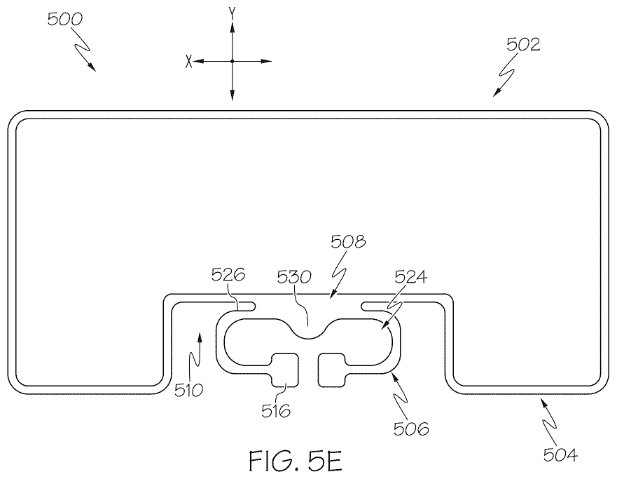

Turning now to FIGS. 5A-5E, there is provided a RFID device 500 having an impedance matching antenna 502 in accordance with a first embodiment. The first embodiment may be referred to as a T-match impedance matching antenna or a modified version of a T-match impedance matching antenna. The first embodiment of the impedance matching antenna 502, which also may be referred to as a T-match antenna, includes a loop antenna 504 and a feeder loop 506. In some embodiments, the loop antenna 504 may have an overall configuration that is circular, oval, oblong, rounded rectangular, rectangular, or similar shape. In some embodiments, there is a conductive bridge 508 for connecting the feeder loop 506 to the loop antenna 504. It is preferred that the conductive bridge 508 provides a physical connection between the feeder loop 506 and loop antenna 504. Feeder loop 506 and loop antenna 504 may overlap in the conductive bridge. The conductive bridge 508 may be provided in a recessed portion 510 of the loop antenna 502. This allows for a compact design for the impedance matching antenna 502 which is particularly suited to be used in labels for packages of high-dielectric materials.

The loop antenna 504 may comprise a top conductive trace 512 or top edge, and one or more opposing conductive segments 514a, 514b. Generally speaking, the terms “top”, “bottom”, “left”, and “right” are relative and are used to orient the outer edges without limiting the device to a particular orientation. As shown in FIG. 5, the conductive segments 514a may be a left or right edge and the conductive segments 514b may be a bottom edge. The opposing conductive segments may be symmetrically arranged. In some embodiments, the loop antenna comprises at least one opposing conductive segment in line with the x-axis and/or at least one opposing conductive segment in line with the y-axis. Preferably, the loop antenna comprises opposing conductive segments in line with both the x-axis and γ-axis. In one embodiment, the opposing conductive segments may be non-meandering and are preferably straight segments. Although this configuration is preferred, in some embodiments, the opposing conductive segments may comprise one or more meanders.

In some embodiments, the loop antenna 504 may comprise a top conductive trace 512 that connects opposing conductive segments 514a, 514b. This connection may form a continuous conductive trace 514a, 514b that adjoins the opposing conductive segments along the top conductive trace 512 to form a loop. In addition, the recessed portion 510 also is defined by a conductive trace 514c.

In some embodiments, the feeder loop 506 comprises pads 516 at each end of the feeder loop. Each of the pads 516 are separated by a gap. The pads 516 may be in a symmetrical configuration. The RFID device 500 may have one or more straps (not shown) configured to connect the pads 516 of the feeder loop 506 to an integrated circuit (IC) chip (not shown). In one embodiment the IC chip may be a UHF RFID chip.

The conductive trace that forms the loop antenna 504 defines a hollow area 518. Preferably the hollow area is greater than 20% of the total area of the loop antenna and more preferably greater than 80% of the total area. In a similar manner as the loop antenna 504, the feeder loop 506 may also define a hollow area.

In some embodiments, the feeder loop 506 may have a configuration that is circular, oval, rounded rectangular, or similar shape. The feeder loop 506 may have a first diameter (d₁) and second diameter. The first diameter (d₁) may be greater than the second diameter. In some embodiments, the first diameter is provided to be in line with the x-axis and the second diameter may be aligned with the y-axis. This positions the feeder loop 506 to have a shape having a first diameter and a second diameter perpendicular to the first diameter.

In some embodiments, to achieve high performance for the impedance matching antenna 502, the antenna is designed so that at least one of the opposing conductive segments 514a, 514b of the conductive trace has a length that is longer than the first diameter (d₁). The opposing conductive segments 514a, 514b may be in line with the x-axis or y-axis. The length of the opposing conductive segments may include the meanders, if present. In one embodiment, both the opposing conductive segments may have a length that is longer than the first diameter. In one embodiment, the opposing conductive segments in line with the y-axis has a length that is longer than the first diameter. In one embodiment, the opposing conductive segments in line with the x-axis has a length that is longer than the first diameter. Using such configurations has been shown to improve the total efficiency and/or radiation efficiency, which can improve the readability of the RFID antenna 500 when placed on or near packages containing high-dielectric materials.

FIG. 5A shows opposing conductive segments 514a that is larger than first diameter (d₁). In addition, opposing conductive segments 514a is longer than opposing conductive segments 514b. FIG. 5B shows another antenna having an opposing conductive segments 514b that is larger than first diameter (d₁). In addition, opposing conductive segments 514b is longer than opposing conductive segments 514c. FIG. 5C shows an embodiment wherein both the opposing conductive segments 514a, 514b are longer than first diameter (d₁). Although the various embodiments are shown, it should be understood that more variations of the loop antenna are contemplated based on at least one of the opposing conductive segments having a length that is longer than the first diameter.

As shown in FIGS. 5A-5C, the top edge 512 of the conductive trace may be non-meandering. In some embodiments, the top edge 512 may comprise one or more meanders 522 as shown in FIG. 5D. The number of meanders 522 may vary depending on the size of the loop antenna. The number of meanders 522 may be symmetrically arranged on the loop antenna and may range from 2 to 20 meanders, and more preferably from 2 to 10 meanders. Each meander 522 may independently have a meandering height of less than or equal to 6 mm, e.g., less than or equal to 4 mm, less than or equal to 2 mm, less than or equal to 1.5 mm, or less than or equal to 1 mm. Preferably, each meander 522 may have a substantially similar meandering height.

The feeder loop 506 may also comprise a conductive trace. In some embodiments, the conductive trace of the feeder loop 506 may define a hollow area 524 for the feeder loop. The hollow area for the feeder loop may be greater than 20% of the total area for the feeder loop. The average width of the feeder loop may range from 0.5 mm to 2 mm, e.g., from 0.7 mm to 1.6 mm or from 0.8 to 1.2 mm. The average width of the feeder loop 506 may be similar to the conductive trace for the loop antenna. In one embodiment, the average width of the feeder loop may be less than the average width of the conductive trace.

In some embodiments, there is provided a gap 526 between the feeder loop 506 and loop antenna 504. The gap 526 may be provided to separate the feeder loop 506 and loop antenna 504, except for the conductive bridge 508. The gap 526 may represent the minimum coupling height between the feeder loop 506 and loop antenna 504.

As shown in FIG. 5E, in one embodiment, the feeder loop 506 may comprise a nodule 530. The nodule 530 may be rounded or curved and may be positioned in the center of the conductive bridge 508. In some embodiments, the nodule 530 has a symmetrical configuration. The nodule 530 may adjoin the conductive bridge 508 and may be directed towards the pads 516. The nodule 530 may extend into the hollow area 524 and may, in some embodiments, decrease the size of the hollow area 524. Preferably, the nodule 530 does not extend into the recessed portion 510.

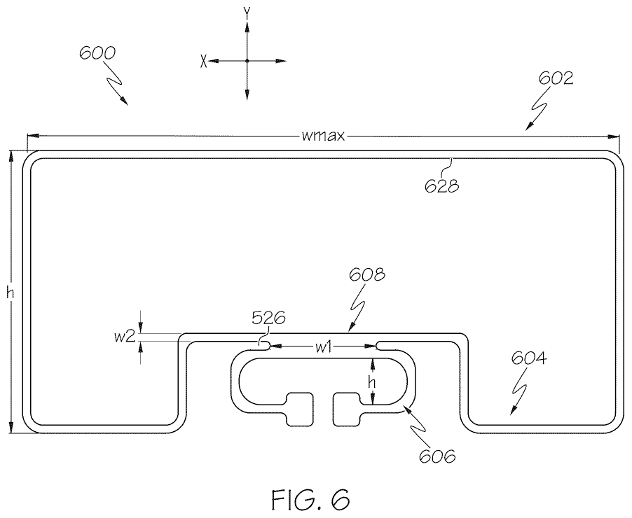

Turning now to FIG. 6, there is provided RFID device 600 having an impedance matching antenna 602 according to the first embodiment. The first embodiment may be referred to as a T-match impedance matching antenna. In one embodiment, the design of the antenna 602 is controlled to have certain parameters to achieve improved performance. The performance using such design parameters have been found to be desirable to increase performance for high-dielectric materials. In one embodiment, the parameters may include the y-height (h) of the feeder loop 606, width (w₁) of the conductive bridge 608, minimum coupling height (g) between the feeder loop 606 and loop antenna 604, maximum width (wₘₐₓ) of the loop antenna 604, perimeter 628 of the loop antenna 604 defined by the conductive trace, and the average width (w₂) of the conductive trace 628. Using such parameters for the first embodiment of the impedance matching antenna has been found to achieve improvement performance for the total efficiency and radiation efficiency. Improved performance is particularly noted for a RFID device having a T-match impedance matching antenna placed on or near high-dielectric components.

In some embodiments, the first embodiment of the impedance matching antenna has a feeder loop 608 having a maximum y-height (h) ranging from 5 mm to 7 mm, e.g., preferably from 5.1 mm to 6.8 mm, and more preferably from 5.3 mm to 6.5 mm. Such values are particularly selected to be used in labels sized to packages of high-dielectric materials, including various types of meat. When the y-height (h) is less than 5 mm, there may be insufficient space to accommodate the IC chip. When the y-height is greater than 7 mm, the feeder loop 606 may perform poorly due to the interaction with the loop antenna. The height may be defined with respect to the two conductive traces of the feeder loop that are separated by the greatest distance in the y-axis direction. This may be referred to as the y-height. Generally, the top edge of the feeder loop 606 may be part of the conductive bridge 608, while the lower edge of the feeder loop may comprise the pads.

In some embodiments, the parameters of the first embodiment of the impedance matching antenna may include the width (w₁) of the conductive bridge 608. Preferably the width may range from 1.7 mm to 6.3 mm, e.g. preferably from 2 mm to 6.3 mm, and more preferably from 4 mm to 6.27 mm. The width of the conductive bridge is generally on the x-axis, but in some embodiments, the conductive bridge may be between the side of the feeder loop and loop antenna. Accordingly, the width of the conductive bridge 608 may be taken on the y-axis. In one embodiment, the conductive bridge 608 is opposite to the pads and preferably the width of the conductive bridge 608 is selected so as to not interfere with the pads, straps, or IC chip.

In some embodiments, the parameters of the first embodiment of the impedance matching antenna may include a minimum coupling height (g) between the loop antenna 604 and the feeder loop 606. This height maintains a minimum gap to separate the feeder loop 506 from the loop antenna 504. The minimum coupling height may be measured in line with the y-axis. In one embodiment, the minimum coupling height may be from 0.8 to 1.7 mm, e.g., preferably from 0.83 to 1.5 mm, or more preferably from 0.87 mm to 1.4 mm. A minimum coupling height at least 0.8 may improve the performance of an RFID device having an antenna when placed on or near high-dielectric materials.

In some embodiments, the loop antenna 604 has a maximum width (x-axis) which is referred to as wₘₐₓ and maximum height (y-axis), which may be referred to as hₘₐₓ. The wₘₐₓ and hₘₐₓ measure the width and height in a straight line and does not measure the conductive trace path, which may include meanders. Each direction measures the maximum length and does not measure the actual path on the x-axis or y-axis. The paths on the x-axis and γ-axis may have meanders and these meander are not accounted for in determining the maximum length. An aspect ratio may be determined by dividing the maximum width and maximum height. The length of the loop antenna on the x-axis, which is the maximum width or the length of the top edge, may range from 50 mm to 75 mm, e.g., preferably ranging from 57 mm to 75 mm, and more preferably ranging from 63 mm to 75 mm. In one embodiment, the first embodiment of the impedance matching antenna may have an aspect ratio of 1.45 to 8.6. Accordingly, the maximum width may be longer than the maximum height. Accordingly, the maximum height on the y-axis of the first embodiment of the impedance matching antenna may be from 6 mm to 52 mm, e.g., preferably may be from 10 mm to 45 mm, and more preferably may be from 15 to 40 mm.

In some embodiments, the conductive trace defines a perimeter 628 of the loop antenna 604. The perimeter 628 may define the path of the conductive trace for the loop antenna 604, which may include any bends or meanders, and/or conductive bridge 608. In one embodiment, the perimeter 628 may be from 174 mm to 200 mm, e.g., preferably may be from 180 to 198 mm, or more preferably may be from 183 mm to 197.5 mm. When the loop antenna 604 has a perimeter 628 of greater than 200 mm, the total efficiency may be decreased, which may be avoid by having a perimeter of less than 200 mm.

In some embodiments, the conductive trace of the loop antenna 604 has an average width (w₂) that is selected to increase performance with high-dielectric materials. The conductive trace may have an average width ranging from 0.8 mm to 1.1 mm, e.g., preferably ranging from 0.82 mm to 1.09 mm, and more preferably may range from 0.83 mm to 1.08 mm. In one embodiment, the conductive trace may be substantially uniform around the perimeter. In some embodiments, the conductive trace may have a greater width, i.e., is thicker, on one edge of the loop antenna 604.

To provide improved total and radiation efficiency, the parameters for the T-matching loop antenna may be provided in accordance with one embodiment as being a maximum y-height may be from 5 mm to 7 mm, conductive bridge width may be from 1.7 mm to 6.3 mm, a minimum coupling height may be from 0.8 mm to 1.7 mm, a maximum width on the x-axis of the loop antenna as ranging from 50 mm to 75 mm, a perimeter of the loop antenna may be from 174 mm to 200 mm, and an average width of the conductive trace may range from 0.8 mm to 1.1 mm. Using these parameters for the T-matching loop antenna, the embodiments disclosed herein may achieve a total efficiency percentage at 902 MHz to 928 MHz that is greater than or equal to 0.09%, e.g., greater than or equal to 0.1%, greater than or equal to 0.11%, or greater than or equal to 0.12%. In terms of ranges, the total efficiency percentage at 902 MHz to 928 MHz may be from 0.09% to 0.15%, e.g., 0.1% to 0.145% or from 0.11% to 0.14%. In addition, the parameters for the T-matching loop antenna may have a radiation efficiency percentage 902 MHz to 928 MHz is greater than or equal to 0.14%, e.g., greater than or equal to 0.15%, greater than or equal to 0.16%, greater than or equal to 0.18% or greater than or equal to 0.20%. In terms of ranges, the radiation efficiency percentage at 902 MHz to 928 MHz may be from 0.14% to 0.21%, e.g., from 0.15% to 0.205%, from 0.16% to 0.2% or from 0.17% to 0.195%.

In one preferred embodiment, the parameters for the T-matching loop antenna may be provided in accordance with one embodiment as being a maximum y-height may be from 5.3 mm to 6.5 mm, conductive bridge width may be from 4 mm to 6.27 mm, a minimum coupling height may be from 0.87 mm to 1.4 mm, a maximum width on the x-axis of the loop antenna as ranging from 63 mm to 75 mm, a perimeter of the loop antenna may range from 183 mm to 197.5 mm, and an average width of the conductive trace may range from 0.83 mm to 1.08 mm. The total efficiency and radiation efficiency described above may be obtained by the preferred parameters.

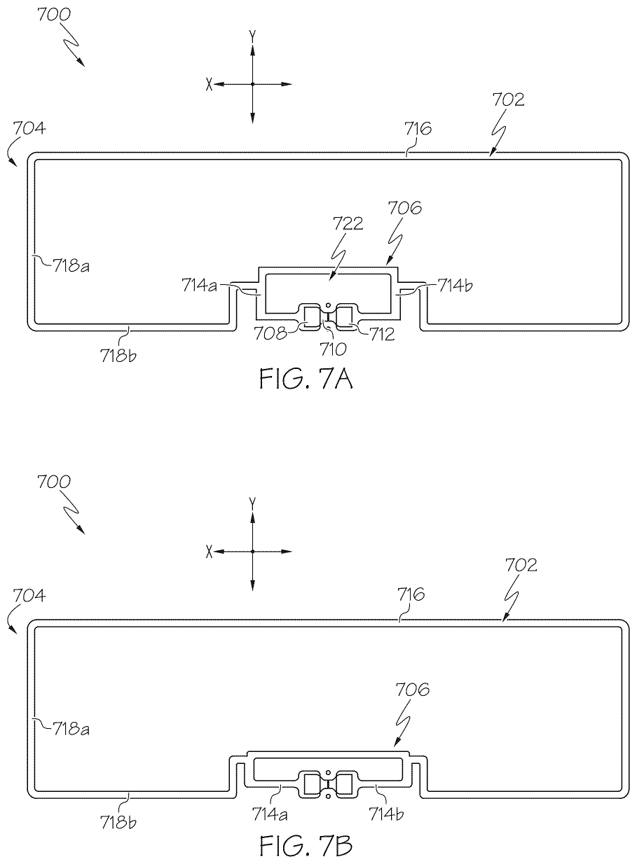

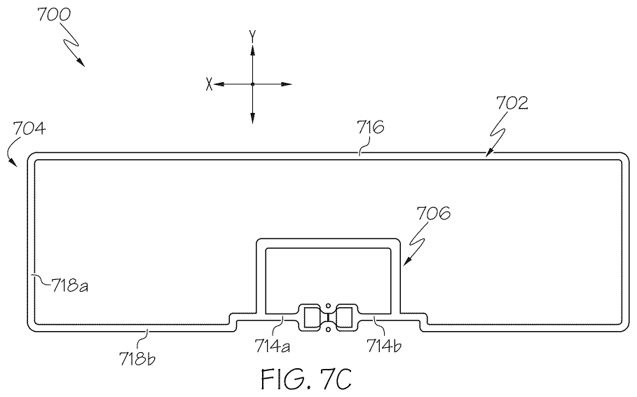

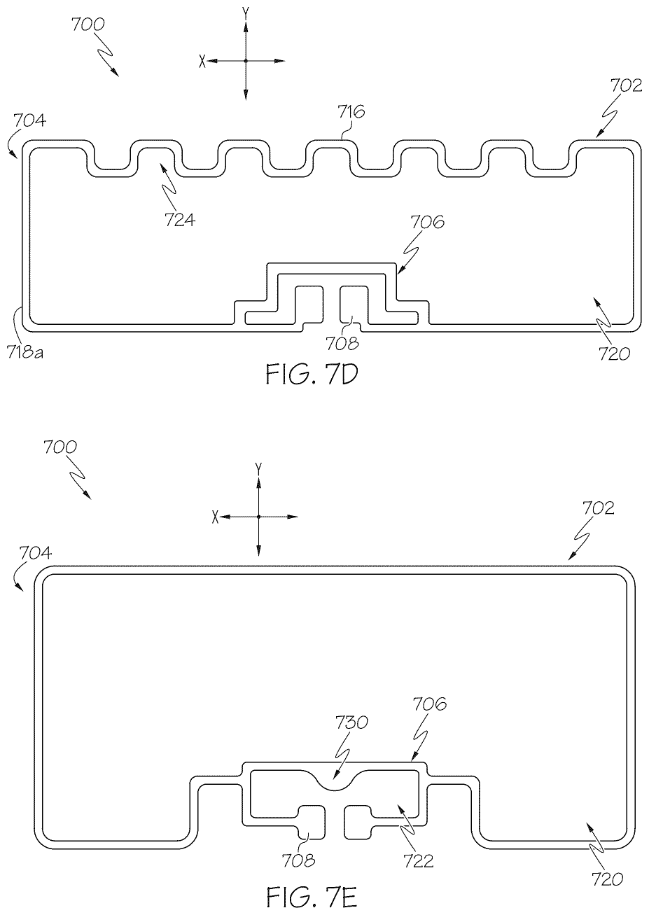

Turning now to FIGS. 7A-7E, there is provided RFID device 700 having an impedance matching antenna 702 according to a second embodiment, wherein the impedance matching antenna comprises a loop antenna 704 and matching loop 706. The impedance matching antenna of the second embodiments may be a reversed T-match impedance matching antenna as shown in FIG. 7C or a modified version of a reversed T-match impedance matching antenna as shown in FIG. 7A or 7B. In some embodiments, the loop antenna 704 and matching loop 706 may each independently have a configuration that is circular, oval, oblong, rounded rectangular, or similar shape. For purposes of the present disclosure, the loop antenna 704 comprises pads 708 at each end. The pads 708 are separated by a gap. The pads 708 may be used to connect to an IC chip 710 directly or may use a strap 712 for connecting to an IC chip 710. In one embodiment, the loop antenna 704 and matching loop 706 may overlap at portions 714a and 714b. These overlap portions 714a and 714b may having the pads 708 mounted at each end. The RFID device 700 may be placed on a label that is attached to a package containing a high-dielectric material.

The loop antenna 704 and matching loop 706 are directly connected. Accordingly the second embodiment of the impedance matching antenna 702, the loop antenna 704 are connected to matching loop 706. This may allow for a compact design for the second embodiment of the impedance matching antenna 702 which is particularly suited to be used in labels for packages of high-dielectric materials.

The loop antenna 704 may comprise a top conductive trace 716 or top edge, and one or more opposing conductive segments 718a, 718b. The opposing conductive segments may be symmetrically arranged as left and right edge segments or top and bottom segments. In some embodiments, the loop antenna comprises at least one opposing conductive segment in line with the x-axis and/or at least one opposing conductive segment in line with the y-axis. Preferably, the loop antenna comprises opposing conductive segments in line with both the x-axis and γ-axis. In one embodiment, the opposing conductive segments may be non-meandering and are preferably straight segments. Although this configuration is preferred, in some embodiments, the opposing conductive segments may comprise one or more meanders.

In some embodiments, the top conductive trace 716 connects opposing conductive segments 718a, 718b. This connection may form a continuous conductive trace that adjoins the opposing conductive segments along the top conductive trace 716 to form a loop.

The conductive trace that forms the loop antenna 704 defines a hollow area 720. Preferably the hollow area is greater than 20% of the total area of the loop antenna and more preferably greater than 80% of the total area. In a similar manner as the loop antenna 704, the matching loop 706 may also define a hollow area. The matching loop 706 may also define a matching hollow area 722. The matching hollow area 722 is smaller in area than the hollow area 720.

As shown in FIGS. 7A-7C, the top conductive trace 716 of the loop antenna may be non-meandering. In some embodiments, the top conductive trace 716 may comprise one or more meanders 724 as shown in FIG. 7D. For reference the top conductive trace 716 is opposite to the side having the pads 708. The number of meanders 724 may vary depending on the size of the loop antenna. The number of meanders 724 may be symmetrically arranged on the loop antenna and may range from 2 to 20 meanders, and more preferably from 2 to 10 meanders. Each meander 724 may independently have a meandering height of less than or equal to 6 mm, e.g., less than or equal to 4 mm, less than or equal to 2 mm, less than or equal to 1.5 mm, or less than or equal to 1 mm. Preferably, each meander 724 may have a substantially similar meandering height. The meanders 724 in FIG. 7D may extend into the hollow area 720 and preferably the meanders 724 do not inference with matching loop 706 or IC chip connected to the pads 708.

As shown in FIG. 7E, in some embodiments, the matching loop 706 may comprise a nodule 730. The nodule 730 may be rounded or curved and may extend from the matching loop 706 into the matching hollow area 722. In some embodiments, the nodule 730 has a symmetrical configuration. The nodule 730 may be directed towards the pads 708. Preferably, the nodule 530 does not extend into the hollow area 720.

Turning now to FIG. 8, there is provided RFID device 800 having an impedance matching antenna 802 according to a second embodiment. In some embodiments, the impedance matching antenna 802 may comprise a loop antenna 804 and a matching loop 806. The loop antenna 804 may have pads 808 at each end configured to connect to an integrated circuit chip. The loop antenna 804 may comprise a conductive trace that forms a dipole loop. The matching loop 806 may connect to the loop antenna 804, wherein the matching loop is contained with the dipole loop. The matching loop 806 is connected to be spaced apart from the pads 808. In some embodiments, the design of the antenna 802 is controlled to have certain parameters to achieve improved performance. The performance using such design parameters have been found to be desirable to increase performance for high-dielectric materials. In some embodiments, the parameters may include that the matching loop has a length (l) ranging from 27 mm to 31 mm, the loop antenna has a maximum height (hₘₐₓ) on the y-axis ranging from 20 mm to 41.5 mm, the conductive trace defines a perimeter and wherein the perimeter ranging from 180 mm to 230 mm, and the aspect ratio of the loop antenna ranging from 1.4 to 3.7.

In some embodiments, the impedance matching antenna of the second embodiment may have a matching loop 806 with a length from 27 mm to 31 mm, e.g. preferably from 28 mm to 30.5 mm and more preferably from 28.4 mm to 29.8 mm. Preferably the matching loop 806 is hollow and the size of the matching loop is selected to provide for readability of the RFID device when placed on a package containing high-dielectric materials. When the length is less than 27 mm, the RFID device may have a reduced total efficiency at the desired frequency range.

In some embodiments, the conductive trace defines a perimeter 828 of the loop antenna 804. The perimeter 828 may define the path of the conductive trace for the loop antenna 804, which may include any bends or meanders, and/or shared portions with the matching loop. The matching loop length and perimeter of the dipole loop may have an overlapping portion. In particular, the conductive traces of the matching loop and dipole loop may be shared. In one embodiment, the perimeter 828 may be from 180 mm to 230 mm, e.g., preferably may be from 190 to 225 mm, or more preferably may be from 200 mm to 220 mm. When the loop antenna 804 has a perimeter 828 of greater than 230 mm, the total efficiency may be decreased, which may be avoided by having a perimeter of less than 230 mm.

In some embodiments, the loop antenna 804 has a maximum width (x-axis) which is referred to as wₘₐₓ and maximum height (y-axis), which may be referred to as hₘₐₓ. The wₘₐₓ and hₘₐₓ measure the width and height in a straight line and does not measure the conductive trace path, which may include meanders. Each direction measures the maximum length and does not measure the actual path on the x-axis or y-axis. The paths on the x-axis and y-axis may have meanders and these meander are not accounted for in determining the maximum length An aspect ratio may be determined by dividing the maximum width and maximum height. The height of the loop antenna on the y-axis, which is the maximum height, may range from 20 mm to 41.5 mm, e.g., preferably ranging from 21 mm to 35 mm, and more preferably ranging from 22 mm to 28 mm. In one embodiment, the impedance matching antenna of the second embodiment may have an aspect ratio of 1.4 to 3.7, e.g., preferably from 2 to 3.5, and more preferably from 2.7 to 3.4. Accordingly, the maximum width on the X-axis of the impedance matching antenna of the second embodiment may be from 28 mm to 155 mm, e.g., preferably may be from 35 mm to 145 mm, and more preferably may be from 45 to 120 mm. In some embodiments, the maximum width of an impedance matching antenna may be longer than the maximum height.

To provide improved total and radiation efficiency, the parameters for the impedance matching loop antenna of the second embodiment, including reverse T-match antennas, may be provided in accordance with one embodiment as having a matching loop with a length ranging from 27 mm to 31 mm, the loop antenna has a maximum height (hₘₐₓ) on the y-axis ranging from 20 mm to 41.5 mm, the conductive trace defines a perimeter and wherein the perimeter ranging from 180 mm to 230 mm, and the aspect ratio of the loop antenna ranging from 1.4 to 3.7, and an average width of the conductive trace may be ranging from 0.8 mm to 1.1 mm. Using these parameters for the impedance matching loop antenna of the second embodiment, the embodiments disclosed herein may achieve a total efficiency percentage at 902 MHz to 928 MHz that is greater than or equal to 0.09%, e.g., greater than or equal to 0.1%, greater than or equal to 0.11%, or greater than or equal to 0.12%. In terms of ranges, the total efficiency percentage at 902 MHz to 928 MHz may be from 0.09% to 0.166%, e.g., 0.1% to 0.15% or from 0.11% to 0.145%. In addition, the parameters for the impedance matching loop antenna of the second embodiment may have a radiation efficiency percentage 902 MHz to 928 MHz is greater than or equal to 0.22%, e.g., greater than or equal to 0.25%, greater than or equal to 0.28%, greater than or equal to 0.29% or greater than or equal to 0.30%. In terms of ranges, the radiation efficiency percentage at 902 MHz to 928 MHz may be from 0.22% to 0.36%, e.g., from 0.25% to 0.35%, from 0.26% to 0.34% or from 0.27% to 0.32%.

For purposes of the present disclosure, the total efficiency and radiation efficiency were measured on a model of a double stacked chicken. The RFID devices were placed in the center of two chicken packages. Each package of chicken was on a foam tray and wrapped in a polyamide film. The foam tray had a thickness of 4.5 mm and a relative permittivity εr=1.1, loss δ=0.046. The polyamide film had a thickness of 0.02 mm and a relative permittivity εr=4.3, loss δ=0.004. The chicken had a dimension of 380 mm×225 mm with a thickness of 40 mm. The relative permittivity of the chicken was εr=56.8, loss δ=0.38.

Preferably the parameters for the reversed T-matching loop antenna may be provided in accordance with one embodiment as having a matching loop with a length ranging from 28.4 mm to 29.8 mm, the loop antenna has a maximum height (hₘₐₓ) on the y-axis ranging from 22 mm to 28 mm, the conductive trace defines a perimeter and wherein the perimeter ranges from 200 mm to 220 mm, and the aspect ratio of the loop antenna ranges from 2.7 to 3.4, and an average width of the conductive trace may range from 0.8 mm to 1.1 mm.

In some embodiments, the RFID device may operate with an impedance matching antenna of the second embodiment that has a matching loop length that is greater than 31 mm. In such embodiments, to avoid losses in radiation efficiency, the area within the matching loop is reduced. Accordingly, this may increase the radiation efficiency and improve performance when the RFID device is placed near or on high di-electric materials.

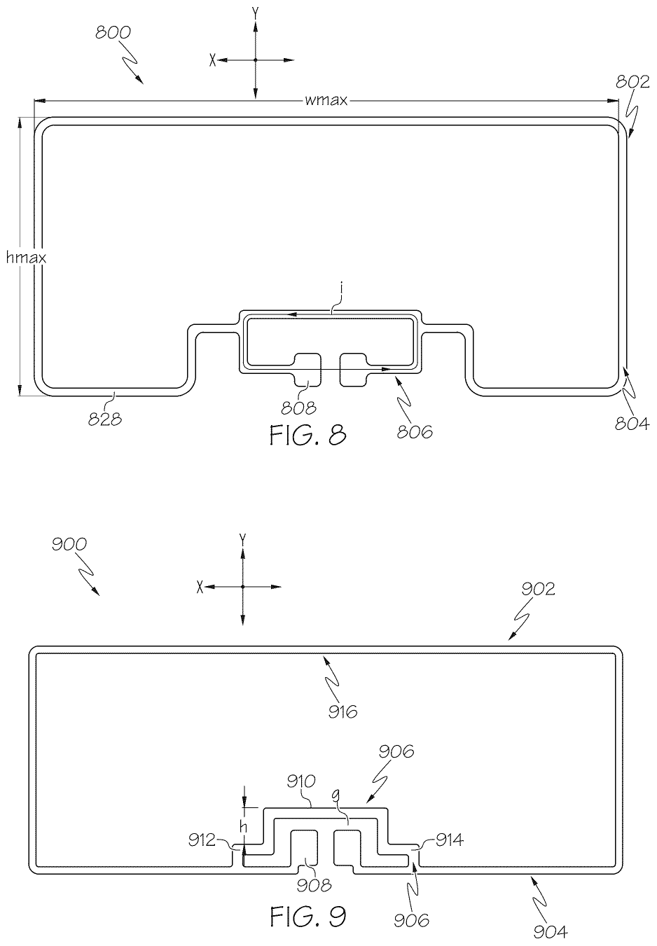

FIG. 9 depicts an environmentally adaptable RFID device 900 with a reversed T-match impedance-matching antenna 902 according to the second embodiment. The reversed T-match impedance-matching antenna 902 may have a loop antenna 904 and matching loop 906. As described above, the loop antenna 904 and matching loop 906 may have a conductive trace that is shared or otherwise overlapping. The loop antenna 904 defines a perimeter with a hollow area. The loop antenna 904 may comprise landing pads 908 for an IC chip. Both loops are formed as conductive traces. As shown in FIG. 9, the length of the matching loop may be longer than 31 mm, e.g., longer than 35 mm or longer than 38 mm.

In some embodiments, the reversed T-match loop antenna 902 may be connected to IC landing pads 908, which are separated from each other by a gap. The matching loop 906 may also be connected to the landing pads 908. This arrangement may provide electromagnetic coupling between the matching loop 906 and the loop antenna 904, potentially improving impedance-matching in various environmental conditions. A folded dipole may be effectively formed by each side of the loop antenna 904 meeting at a connection point 916, thereby forming a continuous loop antenna. In other words, the left and right sides of the loop antenna 904 each may act as a separate dipole that is connected to the other dipole at connection point 916. It will be appreciated that such a connection between each dipole may be made by simply forming each dipole, or the entire antenna structure, out of the same piece of conductive material (e.g., die-cut aluminum or printed conductive ink), rather than by connecting two separate pieces of conductive material. The IC landing pads 908 are designed to receive an IC, which may be connected directly, such as by a conventional direct chip attach process, by using a strap, or by any other means. An IC (and strap) are not illustrated in FIG. 9 for clarity.

Accordingly, the area of the matching loop 906 may be reduced by having a configuration as shown in FIG. 9. The matching loop 906 comprises a top loop edge 910, a first arm 912 and a second arm 914. The top loop edge 910 connects the first arm 912 and the second arm 914. In some embodiments, the first arm 912 may be disposed on one side of the top loop edge 910 and the second arm 914 may be disposed on an opposite side of the top loop edge 910. As connected, the top loop edge 910, a first arm 912 and a second arm 914 define the matching loop 906 having a reduced area. To reduce the area of the matching loop when the length is longer than 31 mm, the first arm 912 and the second arm 914 each have a height difference based on the height the y-axis (h) from the top loop edge 910 that is greater than or equal to the gap (g) between the top loop edge 910 and pads 908. The height difference of both the first arm 912 and the second arm 914 may be the same or substantially similar. Preferably the first arm 912 and the second arm 914 are configured to have a symmetrical configuration. The height is maintained to provide a separation from each arm on the loop antenna 904. When the height on the y-axis (h) has a difference that is zero or negative, the impedance matching deteriorates. To improve the performance the height difference on the y-axis (h) is greater than the gap (g) and because the gap (g) is non-zero, the height difference on the y-axis (h) may be greater than zero. In some embodiments, the height difference on the y-axis (h) is at least 0.5 mm or more, e.g., at least 0.75 mm or more, at least 1 mm or more or at least 1.1 mm or more. The distance of the gap (g) may be from 0.3 mm to 2 mm, e.g., from 0.5 mm to 1.5 mm or from 0.7 mm to 1.2 mm. The height of the y-axis (h) may be from 0.8 mm to 7 mm, e.g., from 0.9 mm to 5 mm or from 1.7 mm to 4.7 mm. In having such configurations, the RFID device has improved readability when placed on packages containing a high-dielectric material.

The loop antenna configurations depicted herein has advantages over conventional, meandering RFID antenna designs. Conventional, meandering RFID antennas have demonstrated that they are not well-suited for use in proximity to high-dielectric materials. As noted above, meandering antennas have many bends that create undesirable areas of high current density. However, in many cases, even if a meandering antenna is straightened out to create a conventional straight dipole, such an antenna is unlikely to work well in proximity to high-dielectric materials. Rather, the various configurations of loop-type antennas disclosed herein exhibit the desirable properties of, for example, low capacitance and high inductance, which enable more effective tuning of the antenna.

In addition, low capacitance and high inductance drives a response from the antenna that is primarily magnetic, rather than electrical, in nature. In other words, creating an electric field maxima that is as small as possible (given the relevant design constraints) causes most of the energy of the antenna to be directed toward generating a magnetic field. This is significant because a magnetic field can more effectively pass through high-dielectric materials than an electrical field, which tends to be absorbed or otherwise impeded.

RFID devices shown herein comprising a RFID integrated circuit chip and an antenna having loops may be adhered or otherwise affixed to a label. The label may be applied to the package containing the high-dielectric material. In some embodiments, the RFID device may be directly applied to the package without using a label. In some embodiments, the antenna may create at least one directional sensitivity pattern configured to intersect with a read aperture of a RFID reader. The antenna improves the read rate of the RFID device when the RFID device is placed on packages containing high-dielectric materials. In one embodiment, the RFID device is applied to a package containing a high-dielectric material the read rate of the RFID device may be greater than or equal to 75%, e.g., greater than or equal to 85% or greater than or equal to 95%. The location of the RFID device on the package may influence the read rate, with read rates being higher on the edges than the center and the top edge of the package generally having higher read rates.

In an embodiment, any of the RFID devices disclosed herein may be combined with a low-loss, low-dielectric (e.g., 1-2 εᵣ) spacer on one or both sides of the RFID device to create separation from high-dielectric materials. In many use cases, the spacer may be needed on both sides of the RFID device to maintain separation from both the package to which the RFID device is affixed, as well as to another package that may be placed on top of the RFID device (for example, as illustrated in FIGS. 3B-D). The stacking can be up to several packages high, and in some cases as many as six packages high, so the presence of a spacer that increases readability could be particularly useful in such situations. The spacer material could be, for example, various types of polyethylene (PE) foam, cavitated polypropylene (PP), polyethylene terephthalate (PET), paper, cardboard, or the like. In some embodiments, the thickness of the spacer is selected so the completed product (e.g., RFID device, the spacer, and the label to which both are attached) can pass through printers and applicators without issues. In such embodiments, the combined thickness of the spacer, the RFID device, and any other layers (e.g., facestock, adhesives, etc.) should be less than 51 mm, e.g., less than 45 mm, less than 40 mm, less than 35 mm, less than 25 mm or less than 20 mm, at least during the printing and application of an inlay or label of which the RFID device may be a part. It will be appreciated that the spacer may have dimensions that are the same or different than the label or the RFID device. In one embodiment, the spacer may be positioned substantially on the bottom and/or top of the RFID device, even if a label to which the RFID device is attached has a larger footprint. In another embodiment, the spacer may cover the entire area of the label.

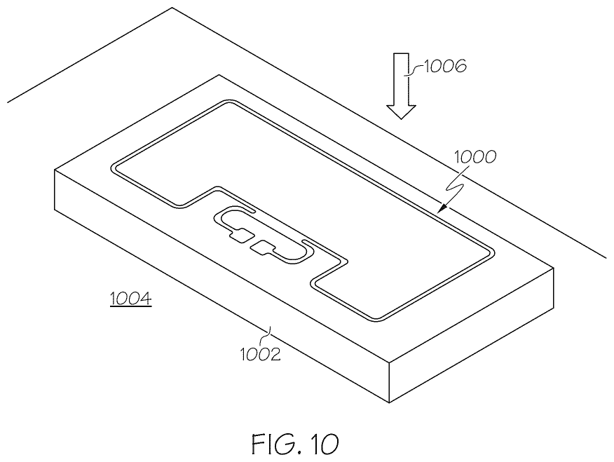

FIG. 10 depicts a RFID device 1000 that has been attached, or placed adjacent to, a spacer 1002. FIG. 10 further depicts the RFID device 100 being attached to a surface 1004 of a dielectric material or package with the spacer 1002 in between, typically by using an adhesive (not shown). As noted above, in an embodiment the spacer 1002 is comprised of a low-loss, low-dielectric material (e.g., 1-2 εᵣ). Although not shown in FIG. 10, the spacer 1000 may be encapsulated by a face layer or similar polymeric layer. This encapsulation may reduce or prevent delamination.

The spacer 1002 of FIG. 10 may, in one embodiment, resist compression forces that may occur substantially in the direction indicated by arrow 1006. In such an embodiment, the objective may be to maintain an amount of separation between the RFID device 1000 and the surface 1004. In another embodiment, when the RFID device 1000 is placed in a stack of packages, the material thickness of the spacer 1002 changes to allow the RFID device 1000 to provide improved performance and the radiation lobes (i.e., radiation pattern) required for desired performance.

In some embodiments, the spacer 1002 may be a low-density material comprising hollow spheres, air gaps or air pockets. In some embodiments, the spacer 1002 may be foamed polymeric film, cavitated polymeric films, patterned adhesives, foamed adhesives, or any combination thereof. In some embodiments, the spacer 1002 may be a topcoat, an adhesive, a primer, an ink layer or any combination thereof comprising hollow spheres including but not limited to polymeric beads, glass beads, glass bubbles or a combination thereof. The hollow spheres or foam or cavities create air gaps and air pockets in the spacer 1002, which in turn creates a low-density environment around the RFID device 1000. The low-density environment around the RFID device helps the RFID device to efficiently operate across a range of dielectric conditions, including high dielectric and conducting environments.

In some cases, the spacer may be a topcoat, an adhesive, a primer, an ink layer or any combination thereof, which is configured to expand upon exposure to an external stimulus. In such cases, the spacer may include expandable particles, foamable materials, or a combination thereof, which on exposure to external stimulus leads to expansion of the spacer. The external stimulus may be, but is not limited to, thermal, physical, radiation, electrical, sound, chemical, magnetic or any combination thereof. For example, in some embodiments the wireless label construction may be exposed to thermal stimuli, including but not limited to induction heating and IR lamps. Examples of physical stimuli may include but are not limited to pressure, vibrations, ultra-sonication, and any combination thereof. Examples of radiation stimuli include but are not limited to UV radiation, laser radiation, electron beam radiation, electromagnetic radiation and any combination thereof.

In some embodiments, the spacer may have a polymeric matrix comprising a polymer selected from starch, vinyl acetate ethylene dispersion, polyvinyl acetate, polyvinyl acetate, polyvinyl alcohol, dextrin stabilized polyvinyl acetate, polyvinyl acetate copolymers, vinyl acetate-ethylene copolymers, vinyl acrylic, styrene acrylic, acrylic, styrene butyl rubber, polyurethane or any combination thereof. In accordance with some embodiments of the present invention, the plasticizer may be selected from the group consisting of polyfunctional alcohol, polyoxyalkylene or polyoxyalkylene derivative (e.g. glycerol, dibenzoates such as diethylene glycol dibenzoate and dipropylene glycol dibenzoate), polyethylene glycol, polyethylene glycol monomethyl ether, polyethylene glycol monoethyl ether, polyethylene glycol dimethyl ether, polyethylene glycol diethyl ether, polypropylene glycol, polybutylene glycol or their copolymers or any combination thereof. The spacer, based on dry weight, may comprise from 20 to 70% by weight of the polymeric matrix and 15 to 50% by weight of the plasticizer, and from 25 to 60% by weight of expandable particles.

In some embodiments, the spacer may comprise an acrylic emulsion having a nonionic surfactant and expandable particles. The acrylic emulsion may comprise 35 to 98% by weight of an alkyl acrylate, 0 to 35% by weight of vinyl ester, 0 to 40% by weight of a diester of a dicarboxylic acid, and 0 to 10% of an unsaturated carboxylic acid. These % by weight are based on the total weight of the acrylic emulsion. The alkyl acrylate may preferably contain from about 4 to about 8 carbon atoms in the alkyl group, preferably 2-ethyl hexyl acrylate or butyl acrylate. The vinyl ester may preferably contain from 2 to about 16 carbon atoms in the alkyl chain of the ester, preferably vinyl acetate. Each alkyl group of the diester independently contains from about 6 to about 16 carbon atoms, with di-2-ethyl hexyl maleate or di-2-ethyl hexyl fumarate being preferred. The unsaturated carboxylic acid may contain from 3 to about 5 carbon atoms, preferably acrylic and/or methacrylic acid. The acrylic emulsion may have a glass transition temperature of less than about −30° C.

The acrylic emulsion may also contain a nonionic surfactant in an amount from 0.4 to 5% by weight of the acrylic emulsion. Suitable nonionic surfactants may include polyethylene polyoxypropylene block copolymers and nonionic emulsified waxes.

The expandable particles may include a polymeric shell and a core. In an embodiment, the expandable particles are thermally expandable particles. The polymeric shell may be made of polymers including but not limited to vinylidene chloride-acrylonitrile copolymers, polyvinyl alcohols, polyvinyl butyrals, polymethyl methacrylates, polyacrylonitriles, polyvinylidene chlorides, polysulfones, or combinations thereof. The core of the expandable may contain hydrocarbons, including but not limited to isobutane, isopentane, or other suitable blowing agents, which vaporize when heated, leading to particle expansion, which in turn increases the thickness and reduces the density of the spacer containing expandable particles.

Alternatively, the foamable materials, upon exposure to external stimuli, lead to foam generation through either physical foam generation or chemical foam generation. In the context used herein, “physical foam generation” refers to a process that involves injecting a gas into a liquid or polymer melt to create a foam due to a change in temperature, pressure, or other physical factors. The material's chemical composition remains the same. In the context used herein “chemical foam generation” refers to a chemical reaction generating gas, which in turn creates foam. The chemical reaction is initiated due to a change in temperature, pressure, or other physical factors. This change creates new substances with different chemical and physical properties. The foamable materials may include but are not limited to blowing agents, foaming agents, a two-component foaming material, surfactants, catalysts, photoacids generators, phase-changing material or any combination thereof. The foam generation leads to expansion of the spacer, resulting in increased thickness and reduced density.

In one embodiment, the spacer may include a particle or layer having a breakable protective layer separating an acid component and a base component. The breakable protective layer may be a silica material, wax, paraffin, or triglycerides that may be ruptured upon application of a force. This causes a rupturing of the contents which may be an organic acid, base or water, that interacts with other components in the polymer matrix to cause expansion. Suitable organic acids may include, but are not limited to, formic acid, acetic acid, propionic acid, butyric acid, lactic acid, malic acid, citric acid, tartaric acid, oxalic acid, succinic acid, glutaric acid, glycolic acid, and ascorbic acid. Suitable bases may include, but are not limited to, sodium bicarbonate, potassium bicarbonate, and calcium carbonate.

The increase in thickness of the spacer, either through expansion or foam generation, creates separation between the RFID device and the high-dielectric and conductive environment. This separation, which may range from a less than a millimeter to several centimeters depending on the degree of expansion or foam generation, helps to reduce interference from high-dielectric and conductive environments that might otherwise impair the performance of the RFID device.

The environmentally adaptable RFID device may also incorporate one or more activatable isolating layers that can change their physical dimensions post-application. These isolating layers may be activated by thermal, ultraviolet, or mechanical force. The activation may cause the isolating layers to expand in one or more dimensions, potentially improving the separation between the antenna structure and the surrounding high-dielectric materials.

The above-disclosed impedance-matching mechanisms may work together or independently to help the environmentally adaptable RFID device maintain desirable levels of performance across a range of dielectric environments. In some cases, the environmentally adaptable RFID device may achieve environmental adaptability through the interaction of various elements, either alone or in any combination. The antenna structure, impedance-matching mechanisms, and adaptive radiation patterns may work together to optimize performance in different environments.

### EXAMPLES

The following examples are provided solely to illustrate the present invention and are not intended to limit the scope of the invention, described herein.

### Example 1—First Embodiment Loop Antenna

Various antenna designs of the antennas shown in FIGS. 5A-5E and 6 with the parameters specified in Table 1 for loop antenna of the first embodiment were built and tested using simulation software, Ansys HFSS. The RFID devices were placed on a label and attached in the center of a package having a foam tray containing chicken wrapped in a polyamide film. Another package of meat was placed above the RFID device tested as demonstrated in FIG. 3C. The model used to test the total efficiency and radiation efficiency. The foam tray had a thickness of 4.5 mm and a relative permittivity εr=1.1, loss δ=0.046. The polyamide film had a thickness of 0.02 mm and a relative permittivity εr=4.3, loss δ=0.004. The chicken had a dimension of 380 mm×225 mm with a thickness of 40 mm. The relative permittivity of the chicken was εr=56.8, loss δ=0.38.

The parameters are reported in Table 1 for each RFID device tested. Examples 1-1 to 1-17 demonstrate improved performance over the comparative examples A1-A20 The total efficiency % and radiation efficiency % at 902 to 928 MHz are reported in Table 1. The inventive examples had a RFID readability of at least 85%.

TABLE 1

| | | | | | | | | |
|---|---|---|---|---|---|---|---|---|
| | | Matching | Conductive | | | | | |
| | trace | loop y- | Bridge | Coupling | Antenna | | | |
| | width | height | Width | Height | X-width | Perimeter | Rad | Total |
| Example | (mm) | (mm) | (mm) | (mm) | (mm) | (mm) | Eff. % | Eff. % |

Inventive Examples

| | | | | | | | | |
|---|---|---|---|---|---|---|---|---|
| 1-1 | 0.994 | 6.34 | 5.01 | 1.36 | 67.30 | 181.65 | 0.1887 | 0.1466 |
| 1-2 | 0.866 | 6.41 | 5.75 | 1.22 | 68.95 | 191.32 | 0.1918 | 0.1410 |
| 1-3 | 1.078 | 5.33 | 6.27 | 1.12 | 71.39 | 183.46 | 0.2056 | 0.1401 |
| 1-4 | 1.078 | 5.33 | 6.27 | 1.12 | 71.39 | 183.39 | 0.2056 | 0.1399 |
| 1-5 | 0.845 | 5.36 | 5.55 | 1.12 | 72.13 | 196.45 | 0.1949 | 0.1371 |
| 1-6 | 0.968 | 5.90 | 4.33 | 1.03 | 70.83 | 185.13 | 0.1816 | 0.1350 |
| 1-7 | 0.874 | 6.39 | 4.10 | 1.24 | 64.95 | 186.64 | 0.1715 | 0.1302 |
| 1-8 | 0.984 | 5.88 | 4.72 | 0.89 | 74.49 | 197.10 | 0.1779 | 0.1273 |
| 1-9 | 0.984 | 5.88 | 4.72 | 0.88 | 74.49 | 197.10 | 0.1776 | 0.1268 |
| 1-10 | 0.833 | 5.34 | 5.60 | 1.18 | 73.56 | 190.90 | 0.2054 | 0.1244 |
| 1-11 | 0.988 | 6.01 | 5.34 | 1.49 | 68.06 | 177.29 | 0.1761 | 0.1238 |
| 1-12 | 0.849 | 5.03 | 3.96 | 1.60 | 74.66 | 179.97 | 0.1633 | 0.1231 |
| 1-13 | 0.826 | 6.27 | 4.05 | 1.54 | 65.85 | 185.92 | 0.1708 | 0.1204 |
| 1-14 | 1.090 | 5.07 | 1.73 | 1.16 | 71.25 | 192.40 | 0.1404 | 0.1169 |
| 1-15 | 0.862 | 6.99 | 5.62 | 0.99 | 52.65 | 174.40 | 0.1988 | 0.1041 |
| 1-16 | 0.862 | 5.06 | 4.64 | 0.95 | 70.21 | 188.08 | 0.2049 | 0.0975 |
| 1-17 | 1.011 | 5.20 | 6.25 | 1.14 | 51.62 | 178.20 | 0.2145 | 0.0901 |

Comparative Examples

| | | | | | | | | |
|---|---|---|---|---|---|---|---|---|
| A-1 | 1.196 | 4.63 | 1.12 | 2.72 | 47.88 | 222.15 | 0.0255 | 0.0221 |
| A-2 | 1.148 | 10.14 | 1.38 | 3.40 | 45.20 | 112.44 | 0.0569 | 0.0056 |
| A-3 | 1.199 | 10.32 | 1.06 | 4.31 | 45.38 | 133.24 | 0.0576 | 0.0037 |
| A-4 | 0.809 | 4.50 | 1.06 | 4.86 | 49.58 | 121.25 | 0.0557 | 0.0435 |
| A-5 | 1.020 | 4.78 | 6.35 | 4.80 | 47.42 | 153.54 | 0.1098 | 0.0350 |
| A-6 | 0.992 | 9.95 | 6.33 | 3.74 | 46.75 | 150.47 | 0.0962 | 0.0320 |
| A-7 | 0.844 | 4.95 | 6.35 | 4.84 | 48.53 | 220.85 | 0.0409 | 0.0251 |
| A-8 | 0.815 | 4.51 | 1.06 | 4.73 | 45.20 | 150.83 | 0.0754 | 0.0251 |
| A-9 | 0.809 | 10.49 | 6.34 | 4.93 | 47.00 | 126.10 | 0.0562 | 0.0102 |
| A-10 | 0.809 | 8.00 | 1.04 | 4.53 | 45.86 | 172.10 | 0.0711 | 0.0094 |
| A-11 | 0.810 | 10.49 | 1.01 | 4.85 | 46.04 | 127.45 | 0.0353 | 0.0046 |
| A-12 | 0.878 | 10.27 | 1.27 | 4.45 | 45.97 | 211.05 | 0.0107 | 0.0007 |
| A-13 | 0.827 | 10.13 | 1.26 | 4.56 | 49.64 | 219.64 | 0.0110 | 0.0004 |
| A-14 | 0.852 | 10.46 | 1.14 | 4.63 | 45.08 | 213.37 | 0.0086 | 0.0003 |
| A-15 | 0.878 | 5.69 | 1.41 | 4.64 | 46.76 | 155.02 | 0.0713 | 0.0616 |
| A-16 | 0.897 | 5.06 | 6.24 | 2.21 | 48.53 | 224.15 | 0.0493 | 0.0289 |
| A-17 | 1.070 | 5.29 | 4.73 | 1.25 | 48.65 | 140.29 | 0.1187 | 0.0703 |
| A-18 | 0.950 | 5.48 | 3.75 | 0.87 | 45.23 | 208.28 | 0.0783 | 0.0168 |
| A-19 | 0.811 | 6.93 | 5.25 | 0.95 | 60.24 | 203.40 | 0.1502 | 0.0684 |
| A-20 | 0.915 | 5.28 | 6.05 | 0.86 | 73.69 | 237.56 | 0.1195 | 0.0250 |

The inventive examples of 1-1 to 1-17 demonstrated improved performance in terms of total efficiency and radiation efficiency over the comparative examples. This is attributed to having a maximum y-height ranging from 5 mm to 7 mm, a width of the conductive bridge ranging from 1.7 mm to 6.3 mm, a minimum coupling height ranging from 0.8 mm to 1.7 mm, a loop antenna having a maximum width on the x-axis ranging from 50 mm to 75 mm, a conductive trace defining a perimeter of the loop antenna and wherein the perimeter ranges from 174 mm to 200 mm, and the conductive trace has an average width ranging from 0.8 mm to 1.1 mm.

Each of the comparative examples (A1-A20) had one or more parameters that were outside of the inventive examples and thus led to poor performance in terms of total efficiency and radiation efficiency.

### Example 2—Second Embodiment Loop Antenna

Various antenna designs of the antennas shown in FIGS. 7A-7E and 8 with the parameters specified in Table 2 for loop antenna of the second embodiment were built and tested using simulation software and double stacked chicken model of Example 1. The parameters are reported in Table 2 for each RFID device tested. Examples 2-1 to 2-25 demonstrate improved performance over the comparative examples B1-B20 The total efficiency % and radiation efficiency % at 902 to 928 MHz are reported in Table 2. The inventive examples had a RFID readability of at least 85%.

TABLE 2

| | | | | | | |
|---|---|---|---|---|---|---|
| | Antenna | Antenna | Matching | | | |
| | Y-Height | aspect | Loop length | | Radiation | Total |
| Example | (mm) | ratio | (mm) | Perimeter | Eff. % | Eff. % |

Inventive Examples

| | | | | | | |
|---|---|---|---|---|---|---|
| 2-1 | 22.44 | 3.36 | 29.01 | 214.11 | 0.3296 | 0.1664 |
| 2-2 | 24.77 | 2.94 | 29.76 | 212.03 | 0.3402 | 0.1653 |
| 2-3 | 23.03 | 3.26 | 28.49 | 214.50 | 0.3269 | 0.1647 |
| 2-4 | 27.27 | 2.72 | 28.83 | 209.07 | 0.3267 | 0.1623 |
| 2-5 | 23.58 | 3.19 | 29.51 | 215.70 | 0.3222 | 0.1610 |
| 2-6 | 27.27 | 2.72 | 28.85 | 209.07 | 0.3244 | 0.1610 |
| 2-7 | 24.59 | 3.06 | 29.62 | 212.03 | 0.3315 | 0.1608 |
| 2-8 | 24.54 | 2.99 | 29.53 | 203.73 | 0.3419 | 0.1607 |
| 2-9 | 27.48 | 2.69 | 29.10 | 205.55 | 0.3295 | 0.1593 |
| 2-10 | 25.47 | 2.88 | 28.69 | 202.31 | 0.3456 | 0.1590 |
| 2-11 | 27.71 | 2.47 | 29.14 | 203.55 | 0.3384 | 0.1558 |
| 2-12 | 24.05 | 3.08 | 28.74 | 205.18 | 0.3315 | 0.1551 |
| 2-13 | 24.05 | 3.08 | 28.77 | 205.19 | 0.3307 | 0.1549 |
| 2-14 | 23.25 | 3.20 | 28.50 | 204.68 | 0.3315 | 0.1525 |
| 2-15 | 28.91 | 2.32 | 29.24 | 207.26 | 0.3131 | 0.1511 |
| 2-16 | 27.75 | 2.65 | 28.26 | 207.56 | 0.3099 | 0.1450 |
| 2-17 | 23.88 | 3.07 | 29.08 | 200.77 | 0.3384 | 0.1415 |
| 2-18 | 23.54 | 3.12 | 28.66 | 201.24 | 0.3577 | 0.1373 |
| 2-19 | 26.87 | 2.85 | 28.69 | 212.54 | 0.3026 | 0.1337 |
| 2-20 | 20.00 | 3.53 | 28.61 | 195.14 | 0.3198 | 0.1151 |
| 2-21 | 32.75 | 1.72 | 30.28 | 196.57 | 0.2876 | 0.1138 |
| 2-22 | 30.75 | 1.79 | 28.75 | 187.53 | 0.3298 | 0.1113 |
| 2-23 | 23.25 | 2.74 | 30.29 | 183.92 | 0.3408 | 0.1023 |
| 2-24 | 31.25 | 2.41 | 29.62 | 225.85 | 0.2336 | 0.0996 |
| 2-25 | 24.78 | 2.85 | 27.14 | 200.77 | 0.3360 | 0.0981 |

Comparative Examples

| | | | | | | |
|---|---|---|---|---|---|---|
| B-1 | 60.75 | 1.03 | 40.805 | 261.78 | 0.0887 | 0.0101 |
| B-2 | 52.25 | 1.09 | 48.595 | 232.90 | 0.1186 | 0.0103 |
| B-3 | 65.25 | 0.85 | 39.205 | 254.01 | 0.0842 | 0.0103 |
| B-4 | 69.70 | 1.09 | 48.756 | 293.38 | 0.0907 | 0.0104 |
| B-5 | 69.92 | 0.73 | 40.779 | 253.88 | 0.0771 | 0.0105 |
| B-6 | 59.25 | 1.26 | 42.765 | 277.91 | 0.0906 | 0.0107 |
| B-7 | 51.25 | 1.35 | 42.445 | 253.33 | 0.0987 | 0.0107 |
| B-8 | 65.69 | 0.78 | 41.426 | 251.14 | 0.0815 | 0.0109 |
| B-9 | 54.25 | 0.96 | 48.285 | 230.33 | 0.1163 | 0.011 |
| B-10 | 47.25 | 1.28 | 49.765 | 230.12 | 0.1363 | 0.0112 |
| B-11 | 67.25 | 0.77 | 37.175 | 271.72 | 0.0666 | 0.0116 |
| B-12 | 45.25 | 1.20 | 31.88 | 217.81 | 0.1643 | 0.0590 |
| B-13 | 47.30 | 1.06 | 35.55 | 226.03 | 0.1203 | 0.0366 |
| B-14 | 49.75 | 1.01 | 38.55 | 203.66 | 0.1487 | 0.0322 |
| B-15 | 56.71 | 0.91 | 36.04 | 220.77 | 0.1090 | 0.0273 |
| B-16 | 58.80 | 0.86 | 35.04 | 222.90 | 0.1097 | 0.0247 |
| B-17 | 51.75 | 1.07 | 39.80 | 229.33 | 0.1300 | 0.0172 |
| B-18 | 49.13 | 1.04 | 53.35 | 205.42 | 0.1661 | 0.0170 |
| B-19 | 46.25 | 1.25 | 46.08 | 222.79 | 0.1652 | 0.0155 |
| B-20 | 61.04 | 0.83 | 52.08 | 225.99 | 0.0992 | 0.0087 |
| B-21 | 43.58 | 1.26 | 27.11 | 218.06 | 0.1628 | 0.0547 |

The inventive examples of 2-1 to 2-25 demonstrated improved performance in terms of total efficiency and radiation efficiency over the comparative examples. This is attributed to having a matching loop having a length ranging from 27 mm to 31 mm, the loop antenna has a maximum height on the y-axis ranging from 20 mm to 41.5 mm, the conductive trace defines a perimeter and wherein the perimeter ranging from 180 mm to 230 mm, and the aspect ratio of the loop antenna is from 1.4 to 3.7.

Each of the comparative examples (B1-B21) had one or more parameters that were outside of the inventive examples and thus led to poor performance in terms of total efficiency and radiation efficiency.

### Example 3

A reversed T-match loop antenna having the configuration of FIG. 9 was tested. The dimensions of the antenna are maximum width of 68 mm and a maximum height of 26.4 mm for an aspect ratio of 2.57. The matching loop length of this example was 39 mm, and the matching loop had a reduced area. The gap between the top edge of the matching loop and pads was 1.35 mm, and the height from the first arm to the matching loop was 4.19 mm. The RFID device was placed on the center of a package containing chicken as described in Example 1 and the total efficiency at 902 MHz to 928 MHz was determined to be 0.14% and the radiation efficiency at 902 MHz to 928 MHz was determined to be 0.34%. These values are the minimum values within the ranges.

### Example 4

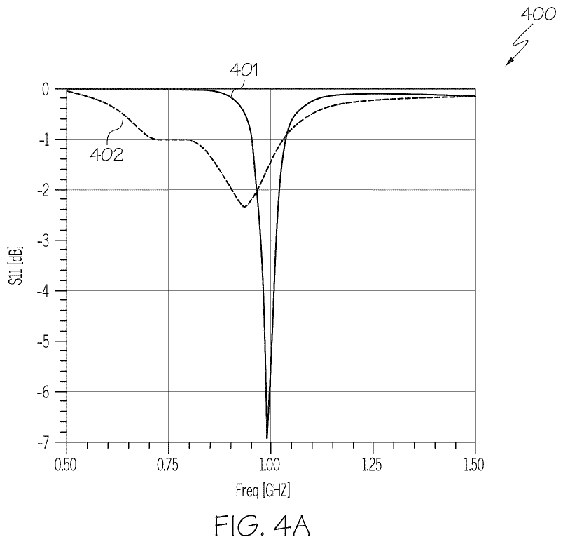

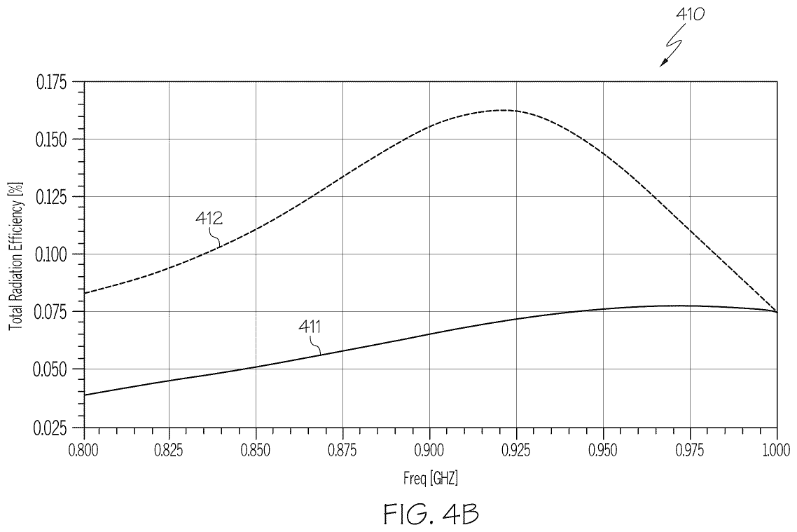

To illustrate how specific efficiency and frequency response characteristics may differ in different environments, FIG. 4A provides a graph 400 of reflection coefficients (“S11” in FIG. 4A) for the reversed T-match loop antenna having the configuration of FIG. 9. The double stacked chicken model of Example 1 was used with the different dimension: 225 mm×165 mm×40 mm. The graph 400 of reflection coefficients includes a plot of a RFID device having the reversed T-match loop antenna in free air 401 and a plot of a RFID device having the reversed T-match loop antenna between two high-dielectric materials 402. The plot of a RFID device having the reversed T-match loop antenna on high-dielectric material 402 may show a broader bandwidth at a lower frequency at a lower frequency compared to the plot of a RFID device having the reversed T-match loop antenna in free air 401.

The differences between plots 401 and 402 may demonstrate how the RFID device having the reversed T-match loop antenna may adapt to different environments. When placed on or near the lossy and high-dielectric material, the resonance frequency of the RFID device having the reversed T-match loop antenna may shift to a lower frequency range, potentially maintaining effective operation in challenging environments.

FIG. 4B depicts a graph of total radiation efficiency 410 comparing the performance of a conventional dipole loop antenna 411 and an RFID device having the reversed T-match loop antenna 412 having the reversed T-match loop antenna across a frequency range, when in proximity to a high-dielectric material.

A number of implementations have been described. Nevertheless, it will be understood that various modifications may be made without departing from the spirit and scope of the disclosure. Accordingly, other implementations are within the scope of the following claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such a term is intended to be inclusive in a manner similar to the term “comprising” as “comprising” is interpreted when employed as a transitional word in a claim.

What is claimed is:

1. An Radio Frequency Identification (RFID) antenna comprising:
a feeder loop having pads at each end configured to connect to an integrated circuit chip, and having a shape having a y-height on the y-axis,
a loop antenna comprising a conductive trace; and
a conductive bridge configured to connect the feeder loop to the loop antenna to provide a minimum coupling height,
wherein:
the maximum y-height ranging from 5 mm to 7 mm;
the width of the conductive bridge ranging from 1.7 mm to 6.3 mm;
the minimum coupling height ranging from 0.8 mm to 1.7 mm;
the loop antenna has a maximum width on the x-axis ranging from 50 mm to 75 mm;
the conductive trace defines a perimeter of the loop antenna and wherein the perimeter ranging from 174 mm to 200 mm; and
the conductive trace has an average width ranging from 0.8 mm to 1.1 mm.

2. The RFID antenna of claim 1, wherein the feeder loop comprising a nodule adjoining the conductive bridge and directed towards the pads.

3. The RFID antenna of claim 1, wherein the conductive trace comprises a top edge trace and wherein the top edge trace is non-meandering.

4. The RFID antenna of claim 1, wherein the conductive trace comprises a top edge trace and wherein the top edge trace has one or more meanderings, wherein each of the one or more meanderings has a meandering height of less than or equal to 6 mm.

5. The RFID antenna of claim 1, wherein the feeder loop has a feeder average width ranging from 0.5 mm to 2 mm.

6. The RFID antenna of claim 5, wherein the feeder average width that is less than the average width of the conductive trace.

7. The RFID antenna of claim 1, wherein the aspect ratio of the loop antenna is the maximum width on the x-axis divided by maximum height on the y-axis, and wherein the aspect ratio is from 1.45 to 8.6.

8. The RFID antenna of claim 1, wherein the radiation efficiency percentage at 902 MHz to 928 MHz ranging from 0.14% to 0.21%.

9. The RFID antenna of claim 1, wherein the total efficiency percentage at 902 MHz to 928 MHz ranging from 0.09% to 0.15%.

10. An RFID device comprising an RFID integrated circuit chip and the antenna of claim 1, wherein the RFID device is applied to a label having at least one adhesive surface and wherein the label is applied to a package containing a high-dielectric material.

11. An RFID antenna comprising:
a feeder loop having pads at each end configured to connect to an integrated circuit chip, and having a shape having a first diameter and a second diameter perpendicular to the first diameter, wherein the first diameter is greater in length than the second diameter;
a loop antenna comprising a top conductive trace that connects opposing conductive segments, and wherein the loop antenna has a recessed portion; and
a conductive bridge opposite to the pads, wherein the conductive bridge connects the feeder loop to the loop antenna portion, wherein the loop antenna portion is connected to the conductive bridge in the recessed portion; and
wherein the top conductive trace is opposite to the conductive bridge, and wherein at least one segment of the opposing conductive traces has a length that is longer than the first diameter.

12. The RFID antenna of claim 11, wherein the top conductive trace is a non-meandering conductive trace.

13. The RFID antenna of claim 11, wherein the top conductive trace comprises one or more meandering segments, and wherein the height of each of the one or more meandering segments is less than or equal to 6 mm.

14. The RFID antenna of claim 11, wherein the top conductive trace has a conductive width that is wider than the conductive widths of the opposing conductive traces.

15. The RFID antenna of claim 11, wherein the first diameter has a length from 8 mm to 25 mm.

16. The RFID antenna of claim 11, wherein the feeder loop is separated from the recessed portion of the antenna dipole region by an conductive distance from 0.2 mm to 2 mm.

17. The RFID antenna of claim 11, wherein the feeder loop comprises an interior nodule opposite the straps, and wherein the interior nodule extends towards the straps.

18. The RFID antenna of claim 11, wherein the at least one segment of the opposing conductive traces has a length ranging from 10 mm to 35 mm.

19. The RFID antenna of claim 11, wherein the opposing conductive traces comprise two segments, and wherein the two segments of the opposing conductive traces each have a length that is longer than the first diameter.

20. An RFID device comprising an RFID integrated circuit chip and the antenna of claim 11, wherein the RFID device is applied to a label having at least one adhesive surface and wherein the label is applied to a package containing a high-dielectric material.
